(19) United States
(12) Patent Application Publication
(10) Pub. No.: US 2005/0177476 A1
(43) Pub. Date: Aug. 11, 2005

(54) System and method for processing professional service invoices

(76) Inventors: Jeffrey W McCandless, Nashville, TN (US); Stephen A. French, Brentwood, TN (US)

Correspondence Address: WADDEY & PATTERSON, 414 UNION STREET, SUITE 2020, BANK OF AMERICA PLAZA, NASHVILLE, TN, 37219, US

(21) Appl. No.: 10/509,924

(22) PCT Filed: Apr. 1, 2003
(86) PCT No.: PCT/US03/09980

Related U.S. Application Data
(60) Provisional application No. 60/368,994, filed on Apr. 1, 2002.

(51) Int. Cl. G06F 17/60

(52) U.S. Cl. 705/32

(57) ABSTRACT

A method of processing professional services invoices begins with importing the invoices in electronic form and storing invoice data from the invoices in a database as electronic invoices. The electronic invoices are published on a computer network to permit access to the electronic invoices by reviewers connected to the network. On-line quality control and peer reviews of the electronic invoices are conducted to determine if adjustments to charges on the invoices should be applied. The method includes generating electronic client invoice reports reflecting the adjustments made by the quality control and peer reviewers and transmitting the client invoice reports to the client.

### BACKGROUND ART

The present invention pertains to the processing of invoices submitted by legal and other professional services firms to their clients. More specifically, this invention relates to systems and methods for automating and expediting the review and processing of professional service firm invoices using a third-party intermediary and online system to provide peer review and quality control.

Large business organizations routinely employ dozens of outside professional services firms such as accountants and attorneys to provide accounting and legal services. For example, a large corporation with geographically widespread business activities will often be involved in hundreds of lawsuits in many jurisdictions. Even though the corporation may have a large law department of its own, it must retain outside counsel in each of these different jurisdictions to assist in handling the litigation. Each of these retained law firms will send invoices to the corporate client for services rendered and costs advanced. Usually, these invoices are sent monthly.

The conventional methods by which invoices from professional services firms are processed by the purchaser of those services include receipt and review of paper invoices by one or more staff members in the department of the purchasing organization that engaged the outside professional services firm. For example, it is customary for an attorney in the law department of a corporation to review invoices sent by outside law firms who have been engaged or who are reporting to that in-house attorney. This is a slow, laborious process that takes away valuable time needed by the in-house attorney to attend to legal matters for which the attorney has been trained. Many invoices sent by outside counsel are not thoroughly reviewed by the corporate client because of lack of time or motivation. As a result, many corporate purchasers of legal services, overwhelmed by the sheer volume of paperwork and invoice detail, are processing and paying invoices that: (1) contain errors (such as incorrect billing rates); (2) do not comply with the agreed-on billing guidelines (such as use of bundled time entries or performance of tasks that have not been authorized); and (3) are excessive in amount compared to the services that have actually been provided.

Another weakness in conventional methods and systems for processing of invoices for professional services is the inability of the corporate purchaser of these services to extract and analyze meaningful qualitative and quantitative data from the invoices. For example, a single outside law firm may send multiple invoices over many months that include time billed on one or more ongoing projects. It has been difficult if not impossible for corporate law departments to unbundle the time entries for each of those projects and track the total charges for a specific project or task over an extended period. Similarly, conventional processing methods do not allow corporate law departments to easily compare and evaluate fees charged by different law firms for different types of projects and tasks. There is no extraction and analysis of comparative data, nor peer review to insure that the hours and fees that are invoiced are reasonable and necessary under the circumstances. This is a particularly acute problem in specialty areas, where the in-house counsel who is reviewing and approving invoices from outside counsel may have little or no background in the specialty that is the subject matter of the representation.

What is needed, then, are a system and method for expediting the review and processing of professional service firm invoices, with improved peer review and quality control.

### DISCLOSURE OF THE INVENTION

To solve the problems presented by conventional methods and systems for processing of professional services invoices, the method of the present invention includes a sequence of steps beginning with importing the invoices in electronic form and storing invoice data from the invoices in a database as electronic invoices. The electronic invoices are then published on a computer network to permit access to the electronic invoices by reviewers connected to the network. Then, using a quality control reviewer connected to the network, a quality control review of the electronic invoices is conducted to determine if adjustments to charges on the invoices should be applied based on non-compliance with billing guidelines set by the client. The electronic invoices are also published to a peer reviewer connected to the network, so that the peer reviewer can perform a peer review of the electronic invoices to determine if adjustments to charges on the invoices should be applied based on the presence of unnecessary or excessive charges in the invoices. Finally, the method includes generating electronic client invoice reports reflecting the adjustments made by the quality control and peer reviewers and transmitting the client invoice reports to the client.

The method of the invention can be implemented in a system for processing invoices that includes a database server, further including a system database for storing invoice data (including charge entries) from the invoices and database software for managing the invoice data stored in the system database. A web server is operatively linked to the database server for publishing the electronic invoice data. An administrative console is operatively linked to both the database server and the web server. At least one information transmission link is used to send the invoices from the law firm to the administrative console, with import software operable to import the invoice data from the invoices into the system database. A communications connection between the system database and a quality control reviewer personal computer is used to allow a quality control reviewer to the charge entries and to add comments and charge adjustments to the invoice data associated with charge entries. Another communications connection between the system database and a peer reviewer personal computer allows a peer reviewer to review the charge entries and to add comments and recommendations to the invoice data associated with the charge entries. A communications connection is also established between the system database and the client to transmit a client invoice report to the client, the client invoice report reflecting the invoice data as adjusted by the quality control and peer reviewers.

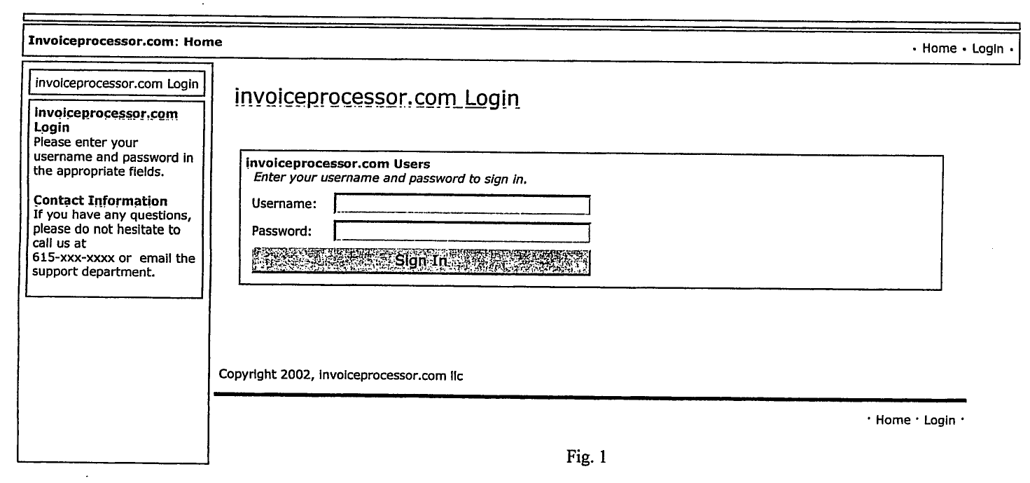

FIG. 1 is a screen shot of the system login page for peer reviewers, law firms, and clients to access the system of the invention. The system provider is identified as “invoiceprocessor.com.”

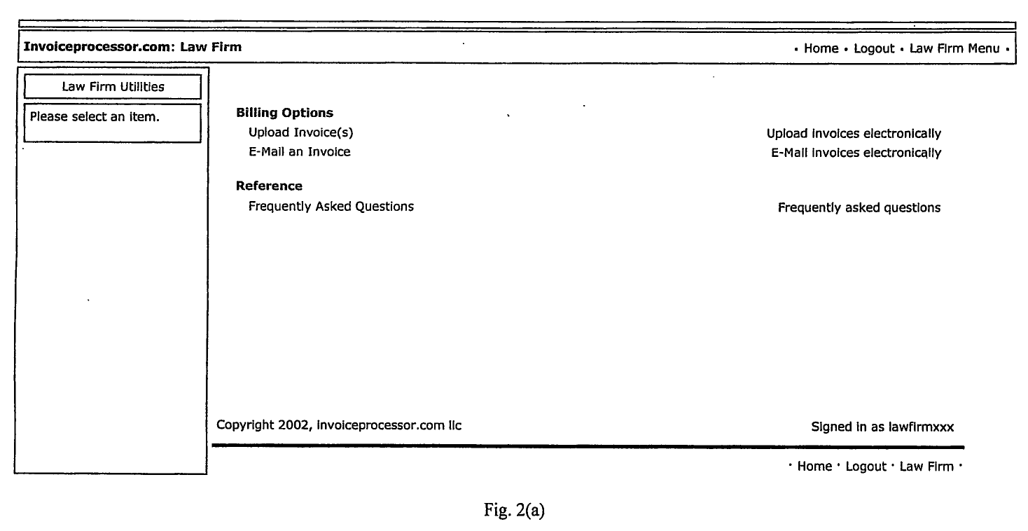

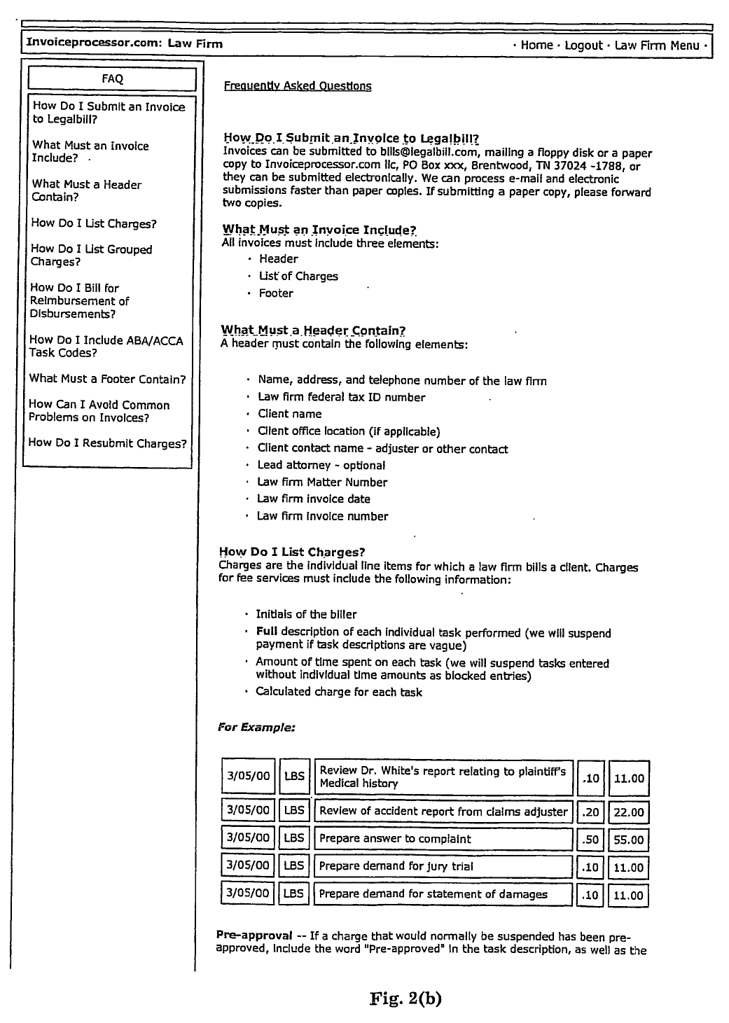

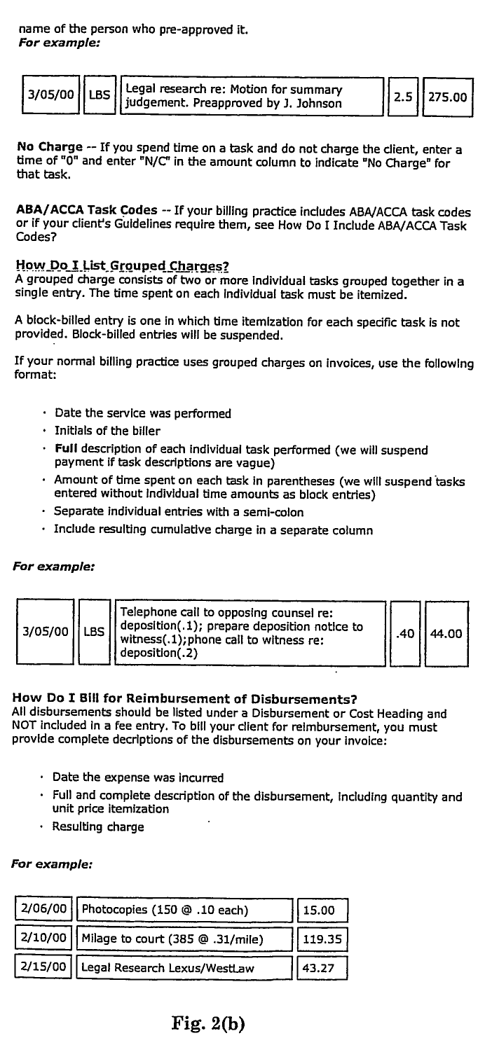

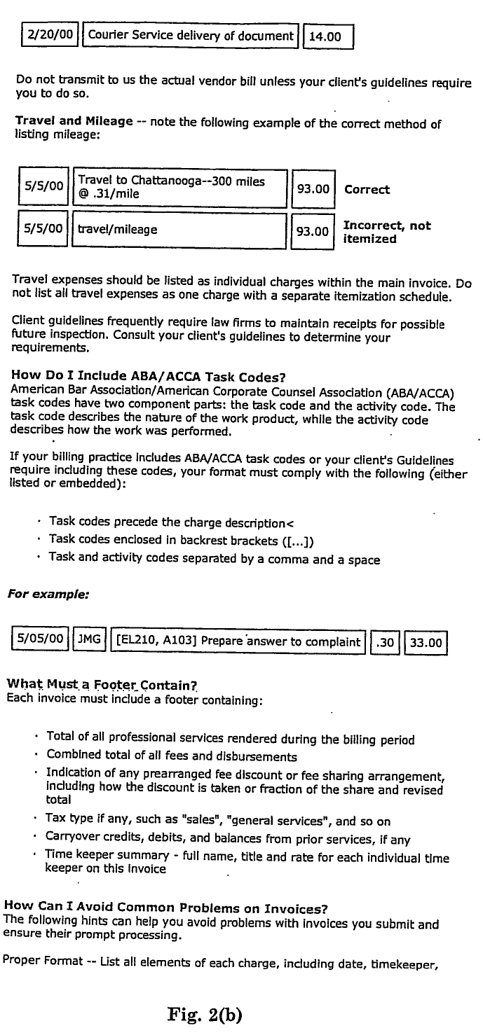

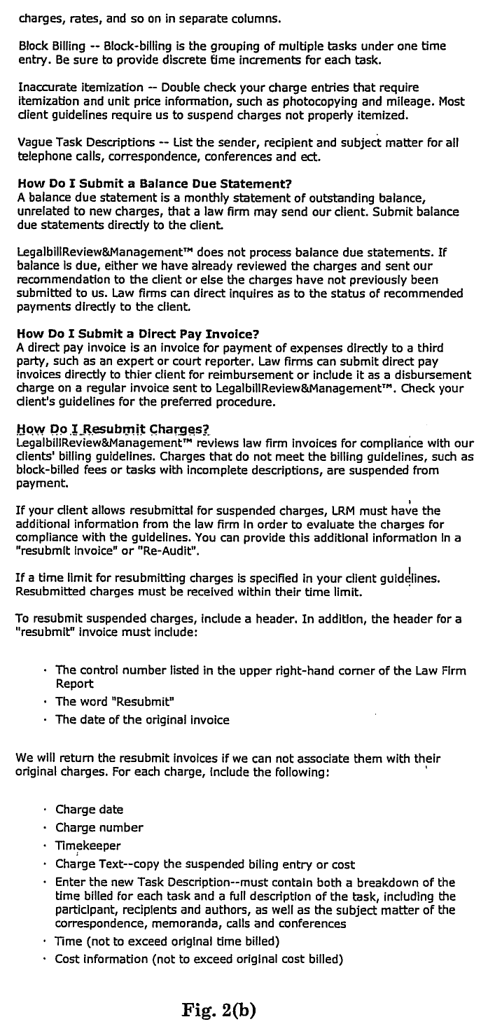

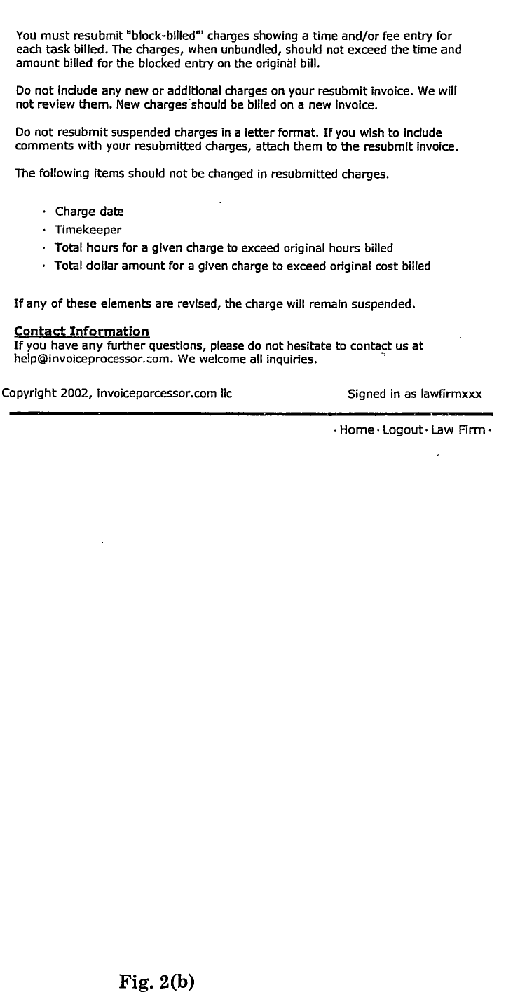

FIG. 2(a) is a screen shot of the law firm menu page displayed after login at the page of FIG. 1 by a system user with law firm credentials.

FIG. 2(b) is a screen shot of instructions and criteria for submitting paper or electronic copies of invoices to the system for review. This page is displayed to a law firm user when the “frequently asked questions” link is selected on the menu page of FIG. 2(a).

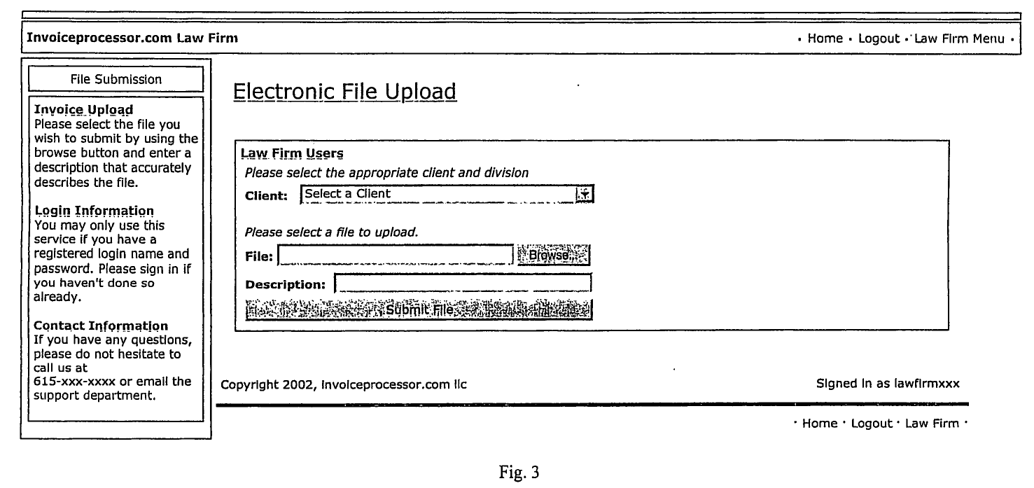

FIG. 3 is a screen shot of the menu page displayed when a law firm user wishes to upload an electronic invoice file into the system and has selected the “upload invoice(s)” link on the page of FIG. 2(a).

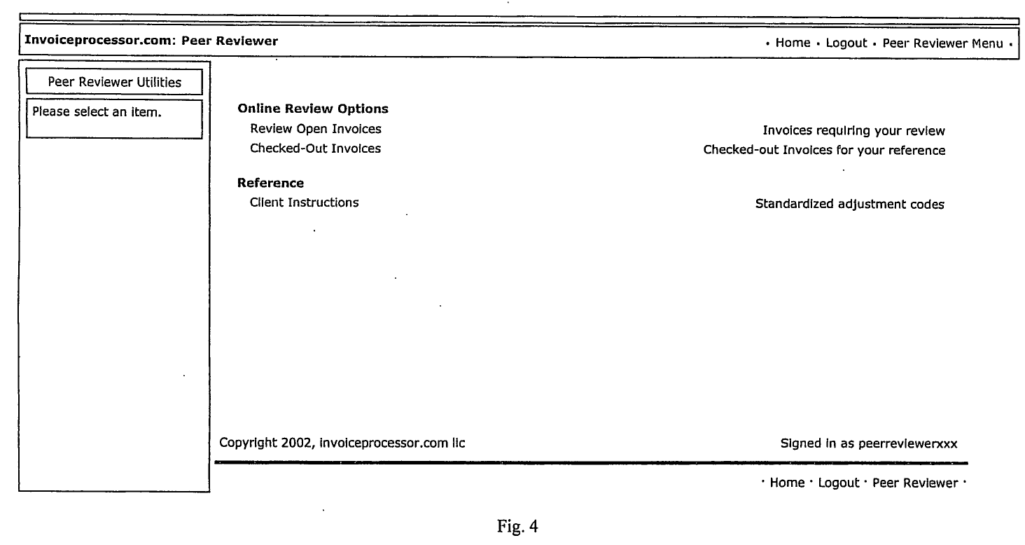

FIG. 4 is a screen shot of the peer reviewer menu page displayed after login at the page of FIG. 1 by a system user with peer reviewer credentials.

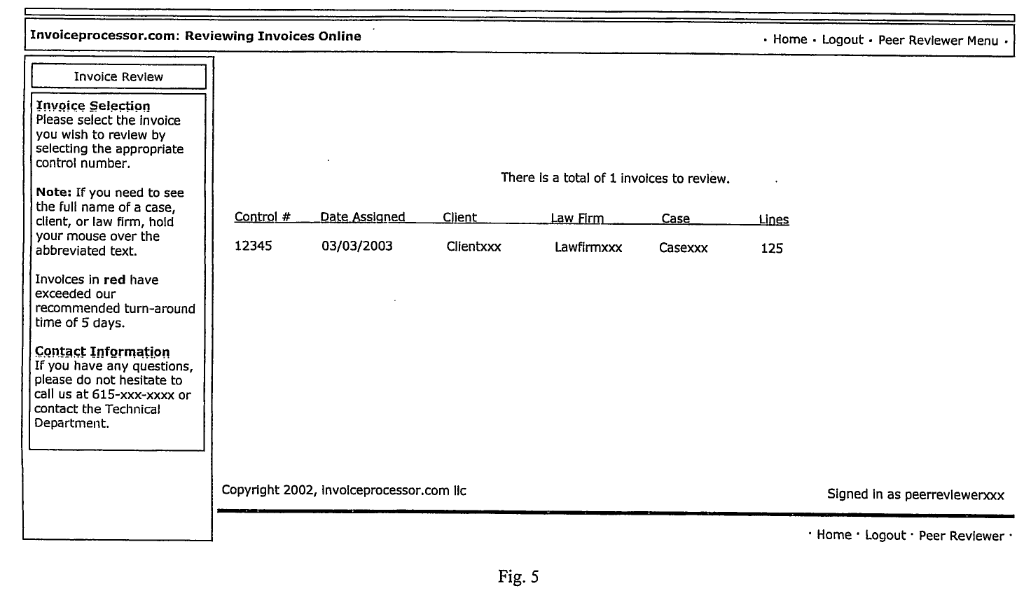

FIG. 5 is a screen shot of page containing a list of open invoices displayed to a peer reviewer user after the “review open invoices” link is selected on the menu page of FIG. 4.

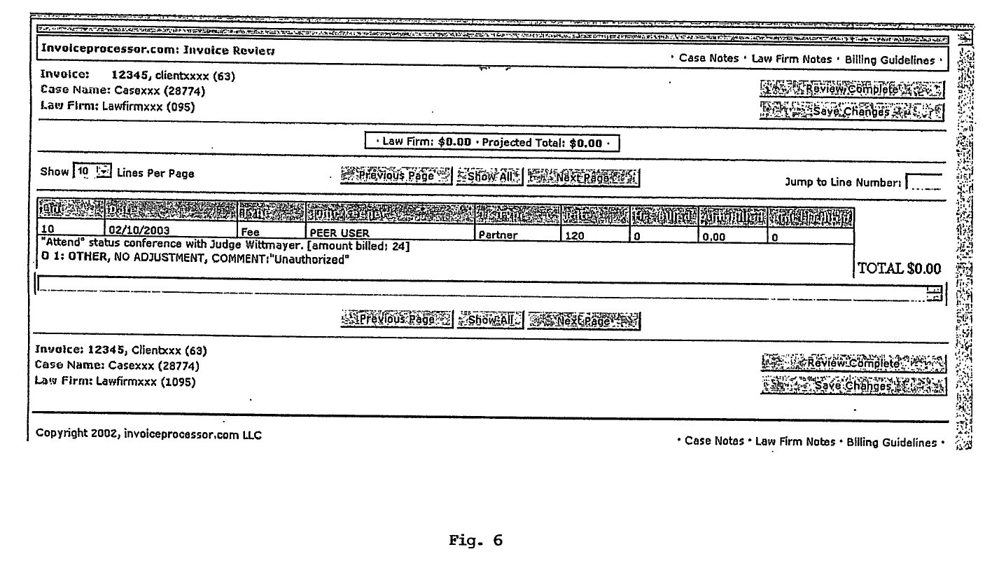

FIG. 6 is a screen shot of a sample invoice that is displayed for online review by a system peer reviewer after the invoice is selected from a list displayed on the peer review invoice page of FIG. 5.

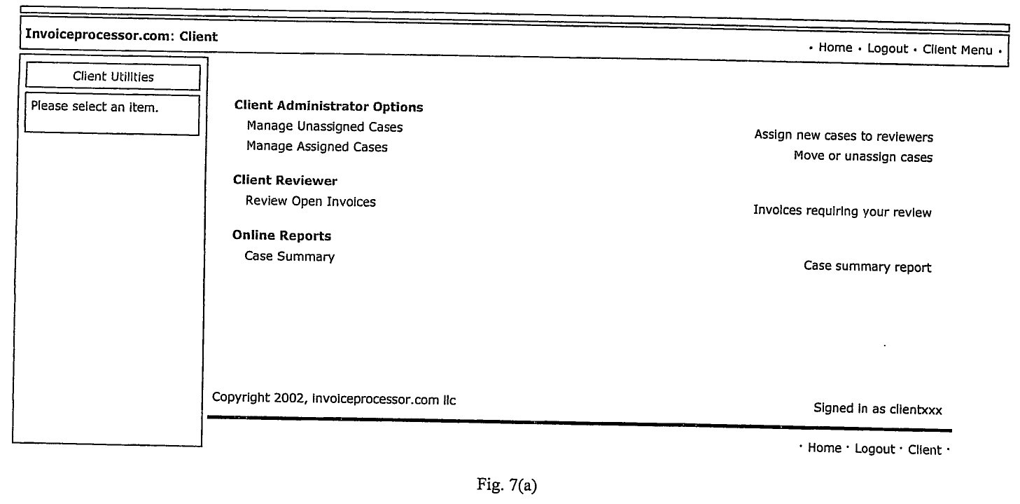

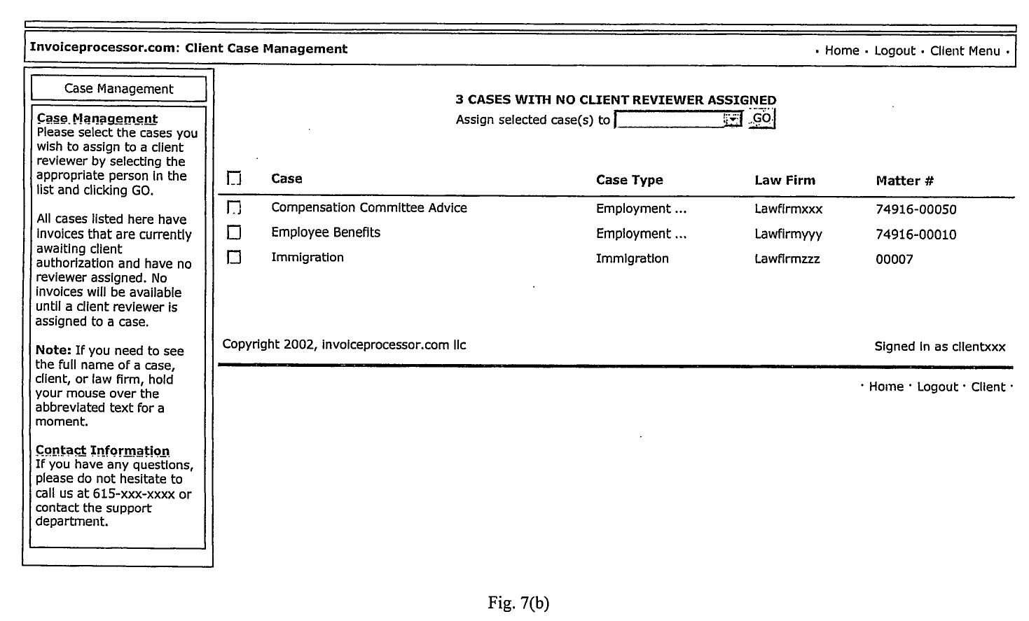

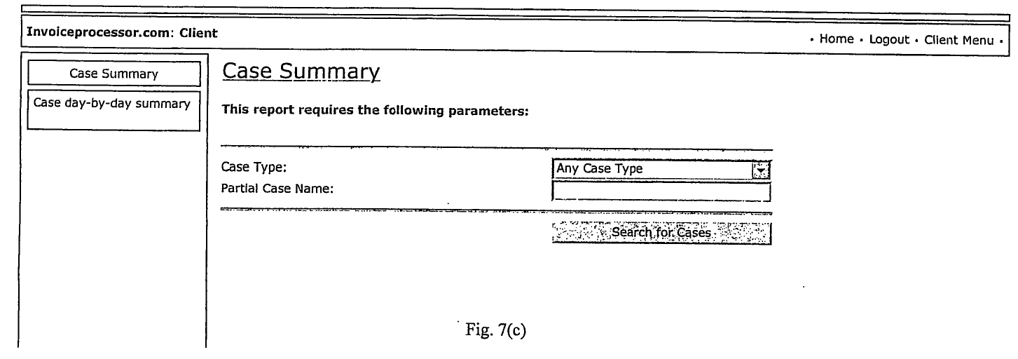

FIG. 7(a) is a screen shot of the client menu page displayed after login at the page of FIG. 1 by a system user with client credentials.

FIG. 7(b) is a screen shot of a client case management page that is displayed to a client user when the “manage unassigned cases” link is selected on the menu page of FIG. 7(a).

FIG. 7(c) is a screen shot of the case summary report page that is displayed when the “case summary” report link is selected on the page of FIG. 7(a).

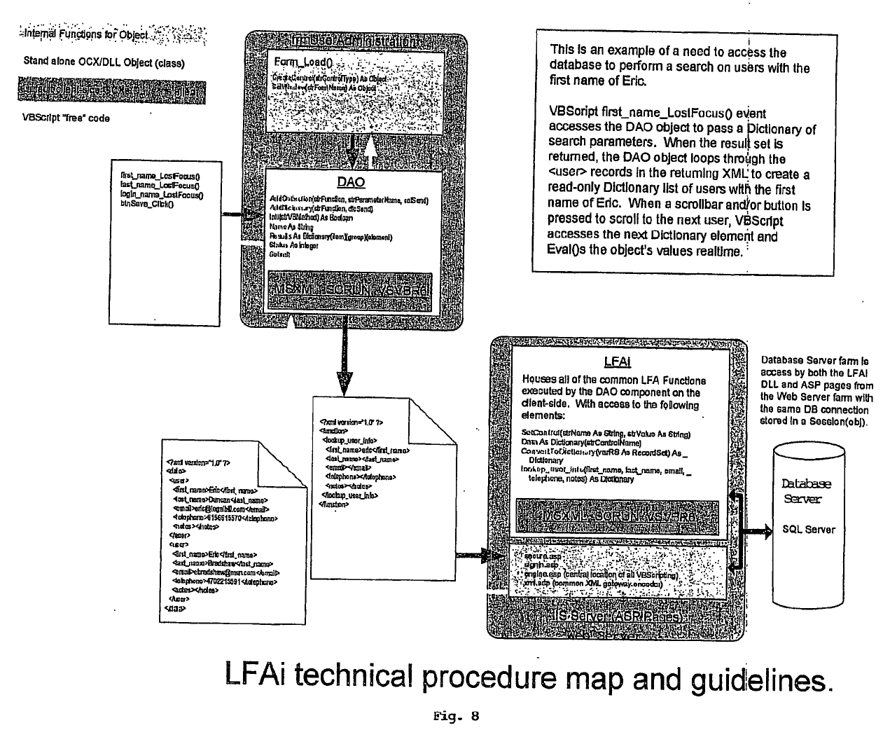

FIG. 8 is a block diagram of the system software architecture.

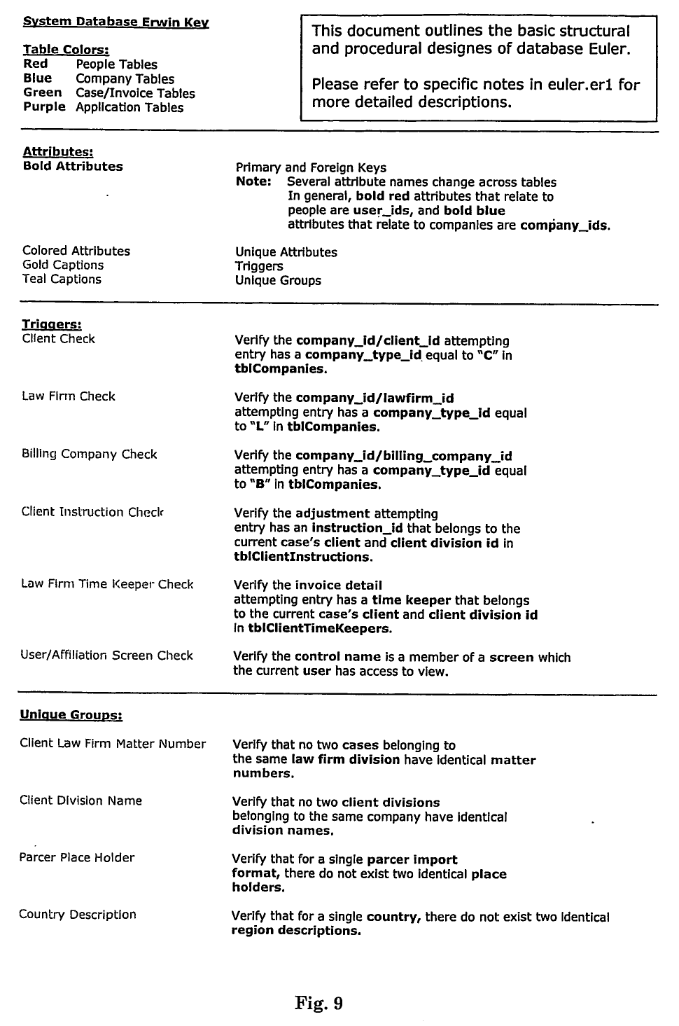

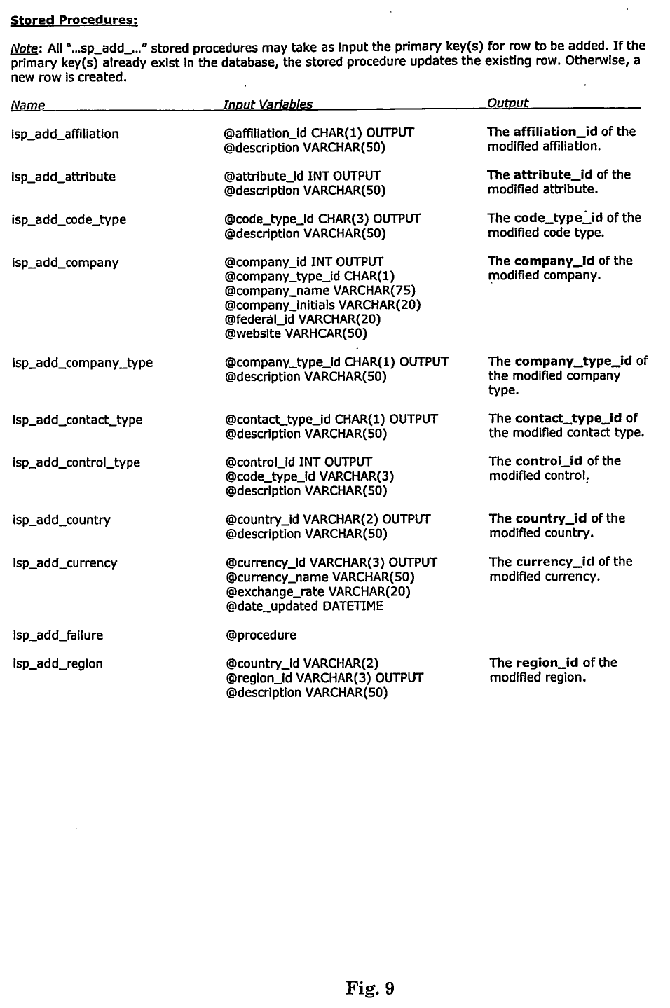

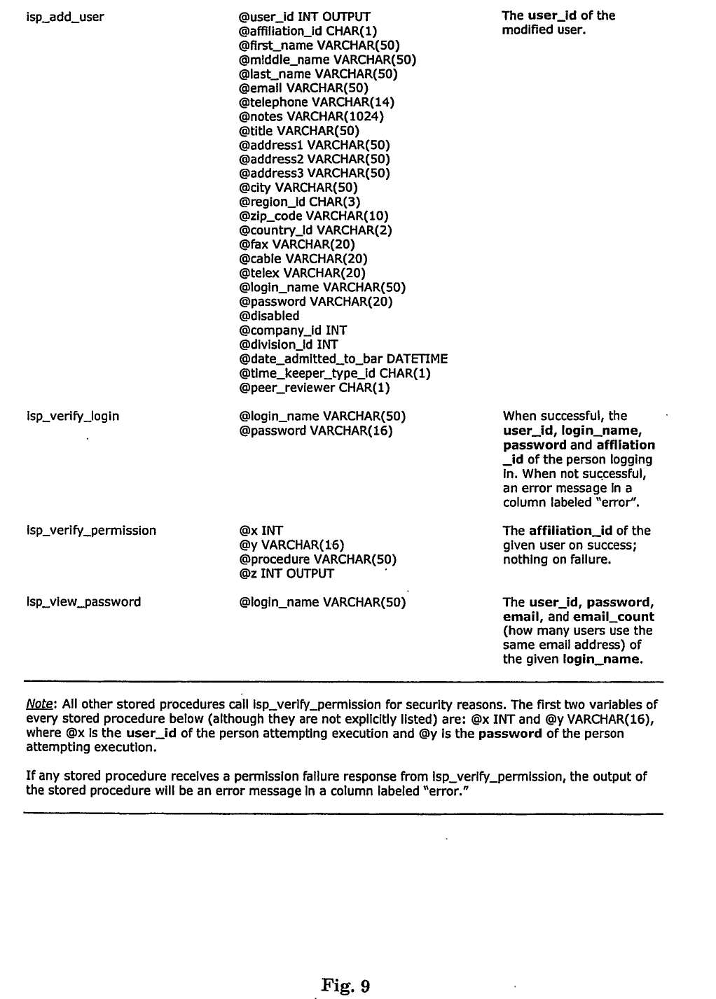

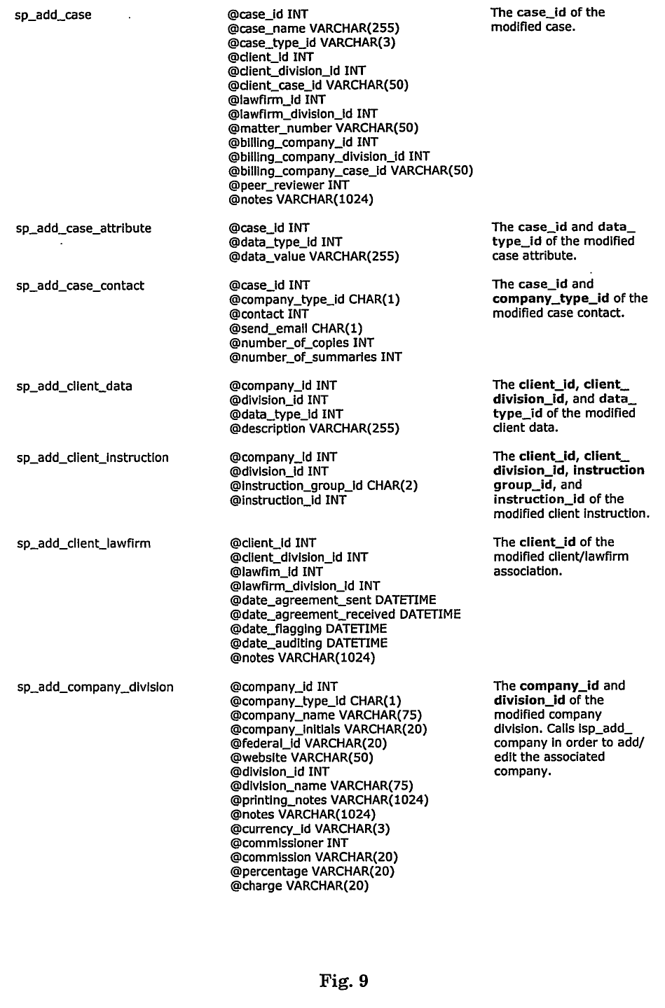

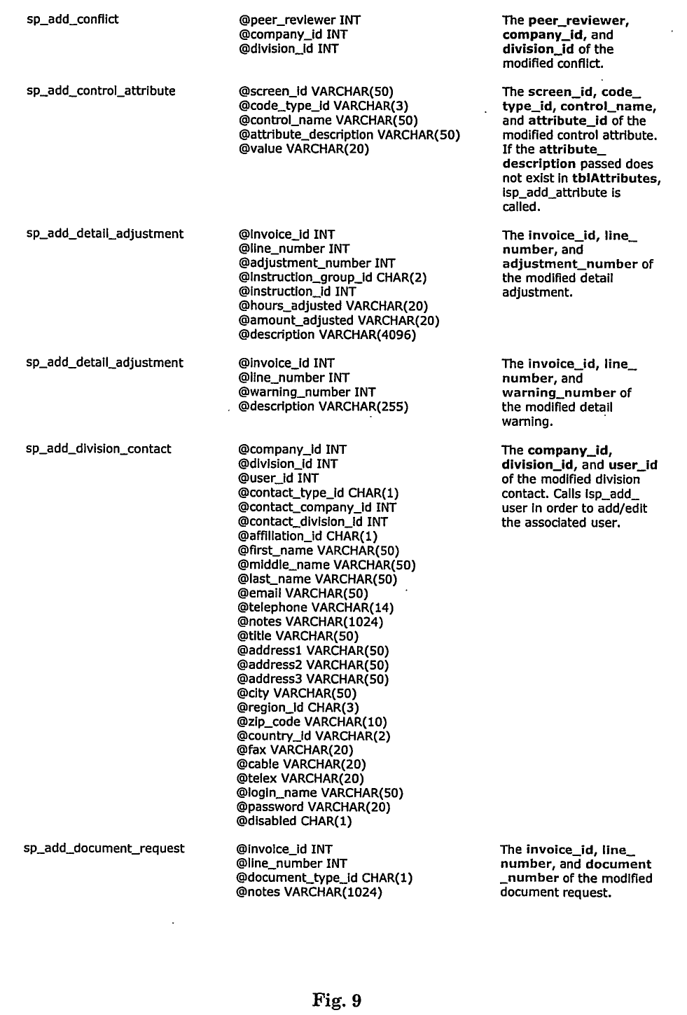

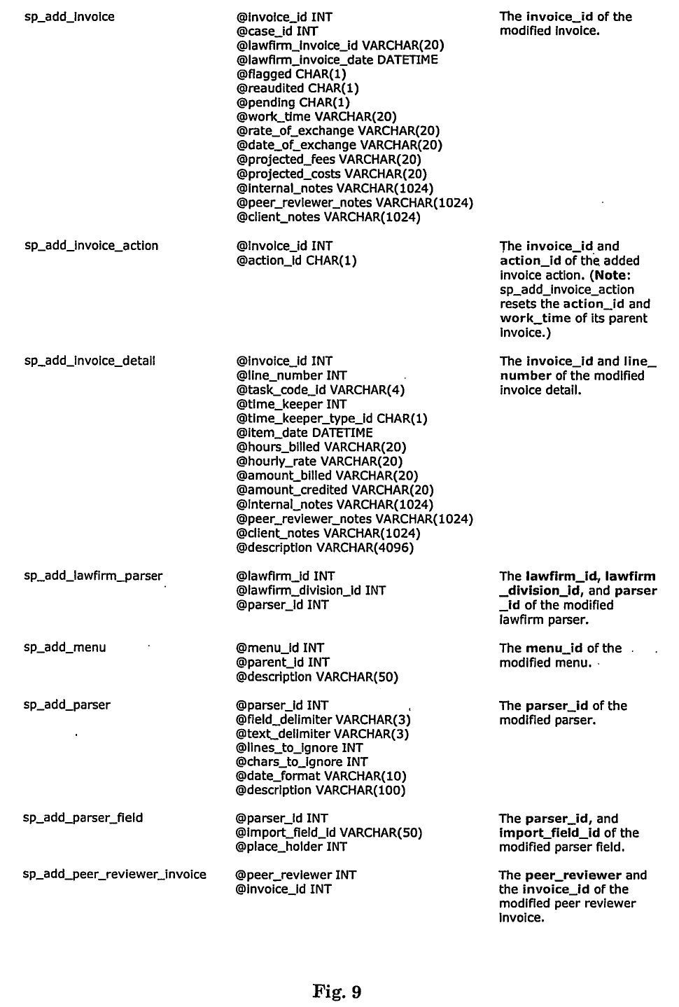

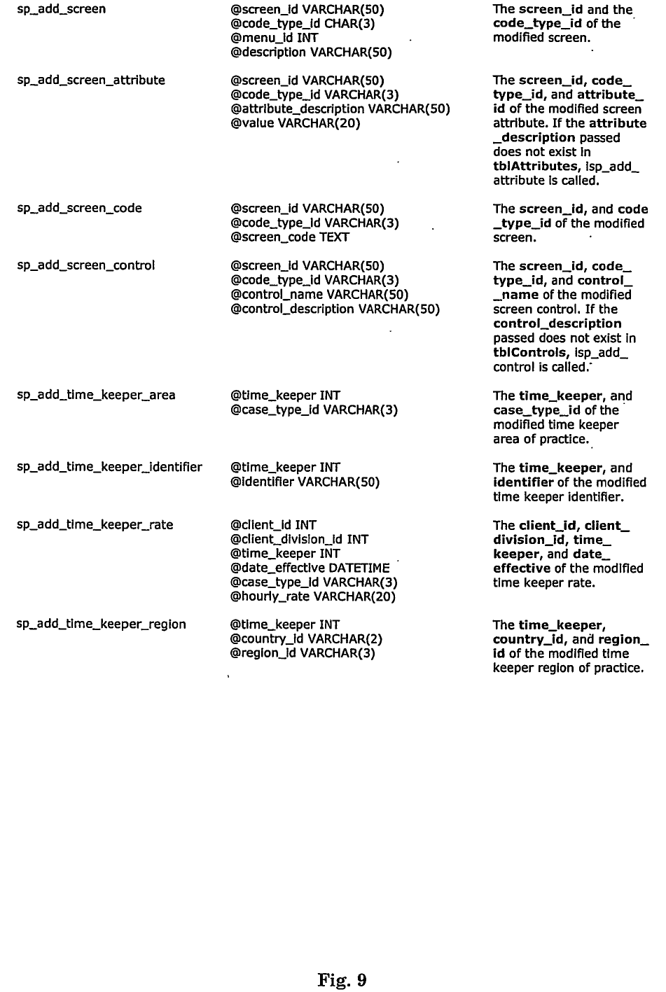

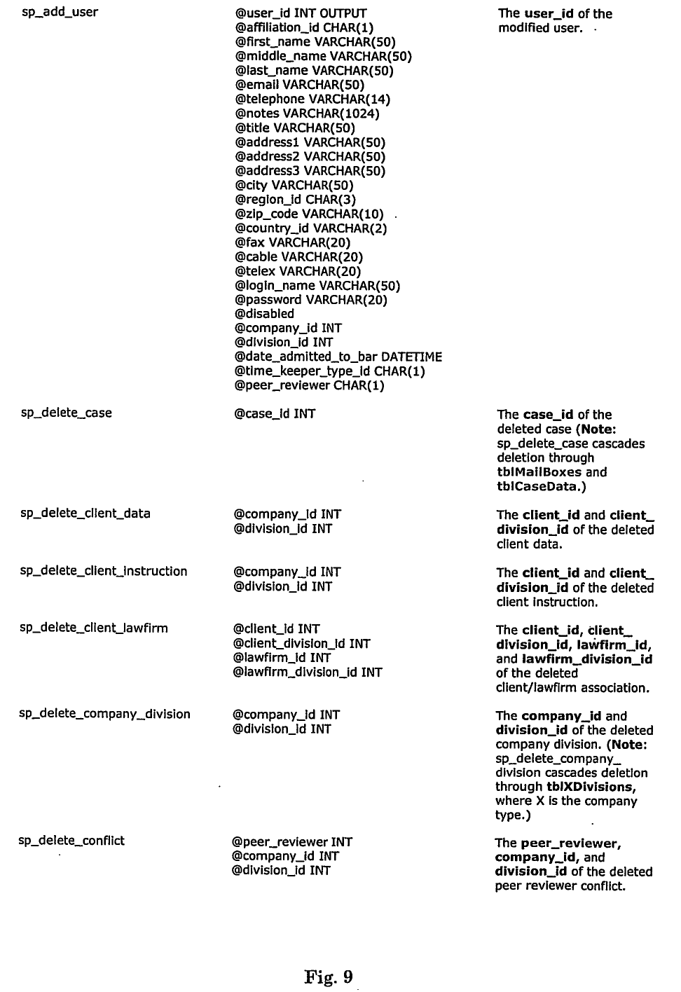

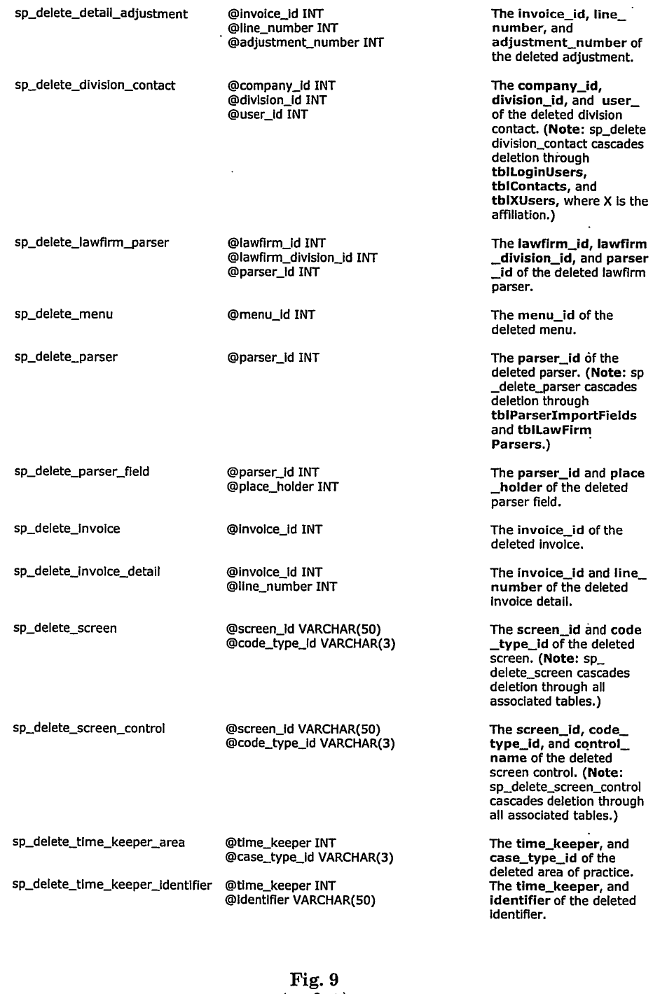

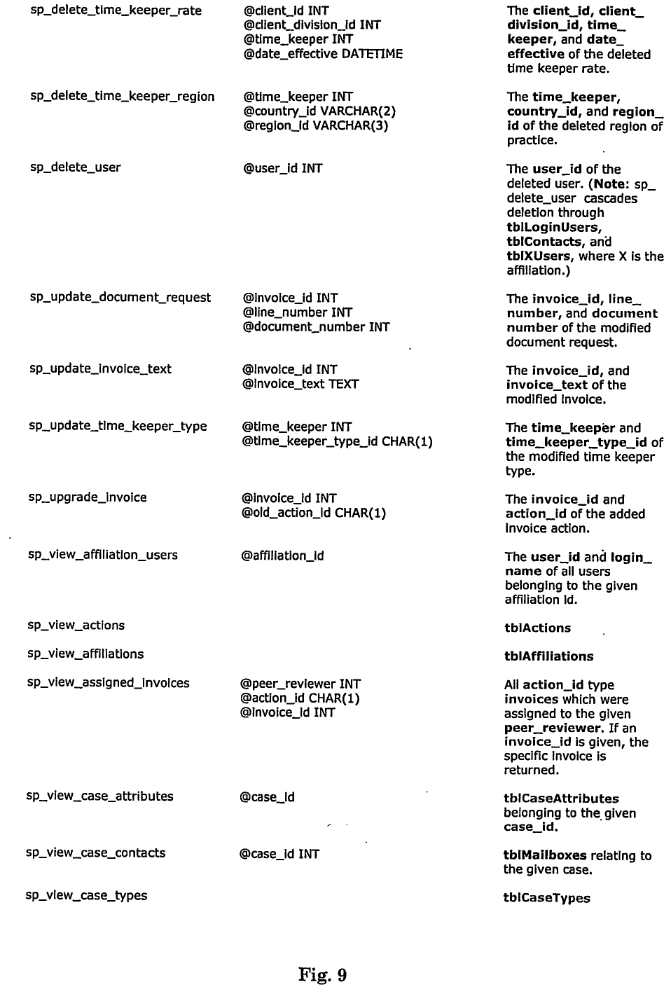

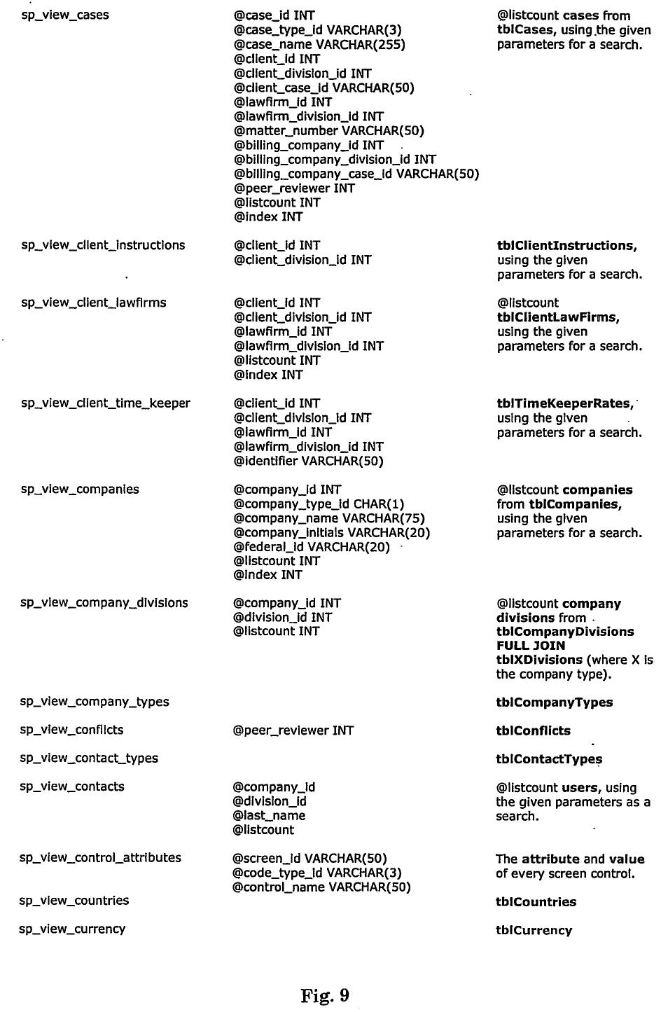

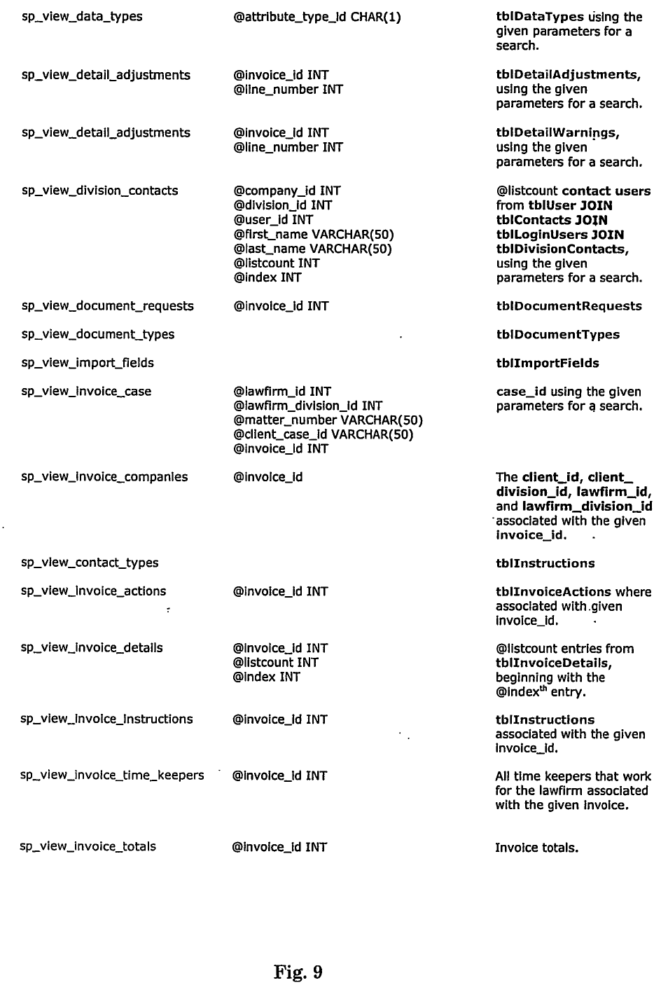

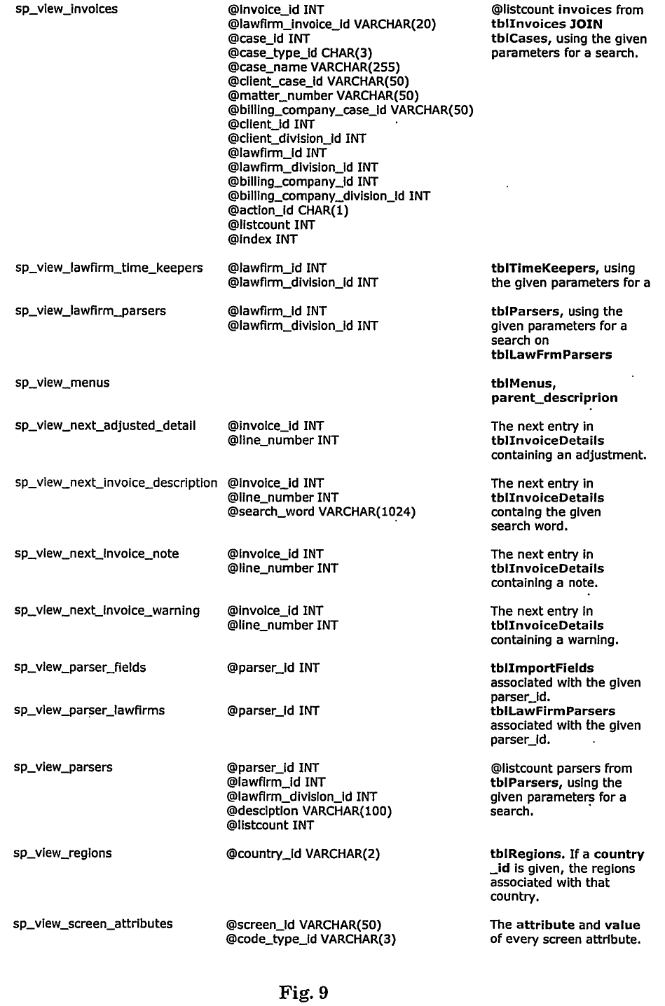

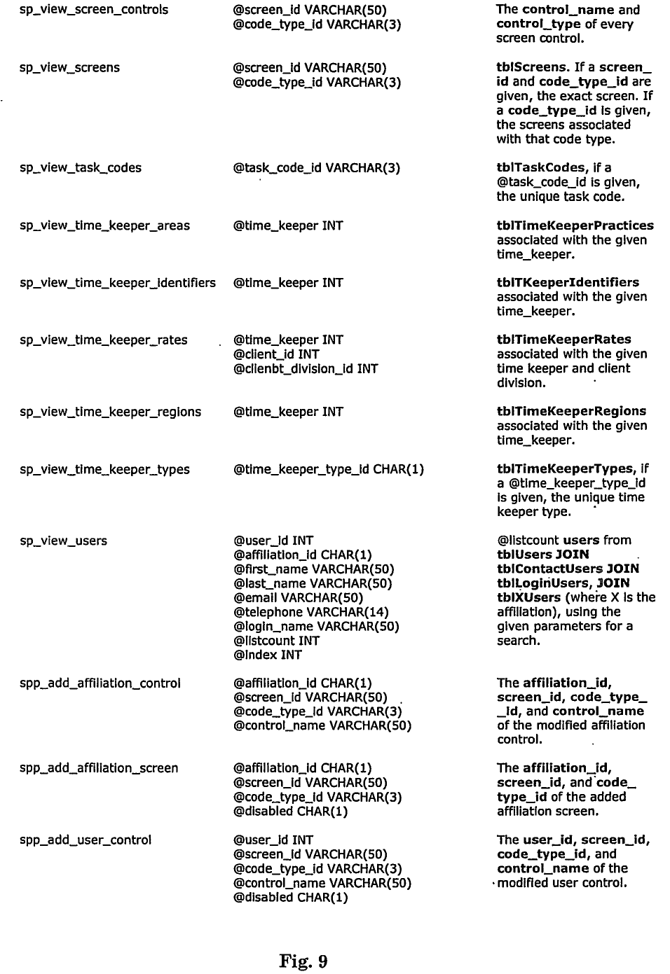

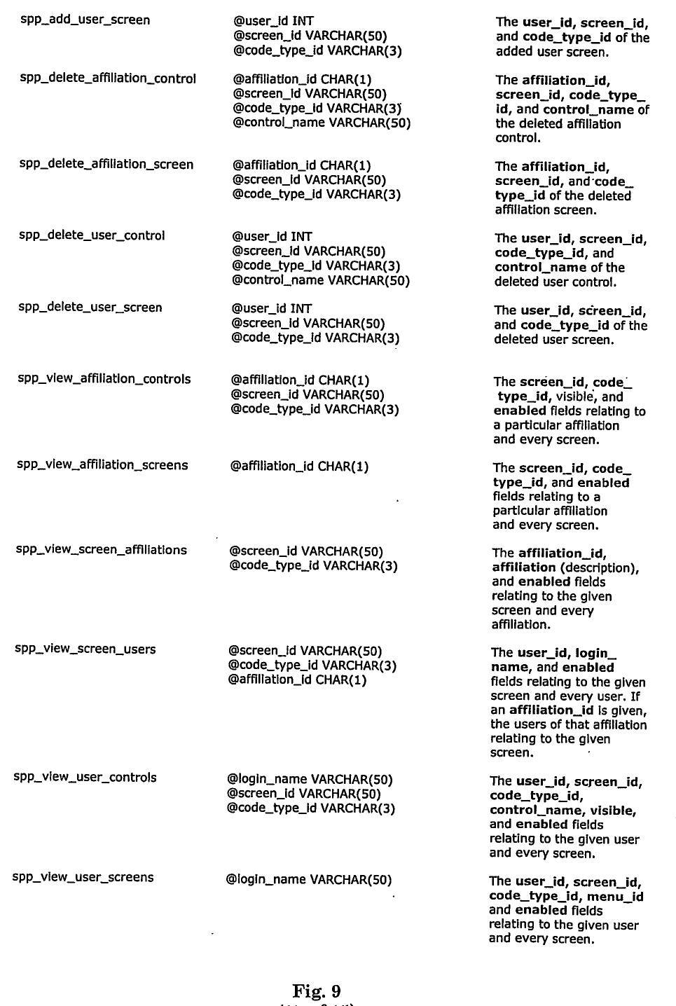

FIG. 9 is a block diagram of the basic procedures used by the system software to access and manage the system database.

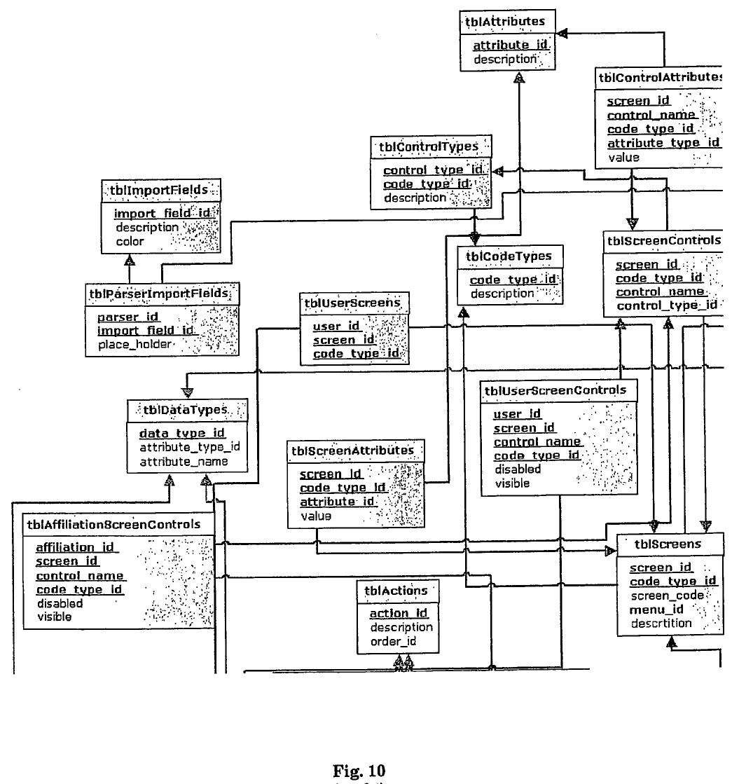

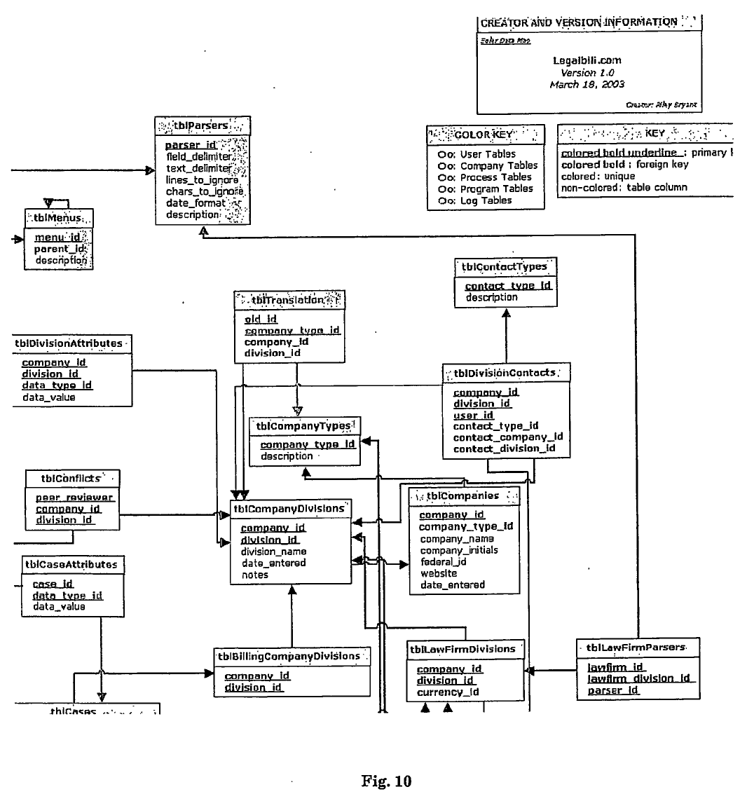

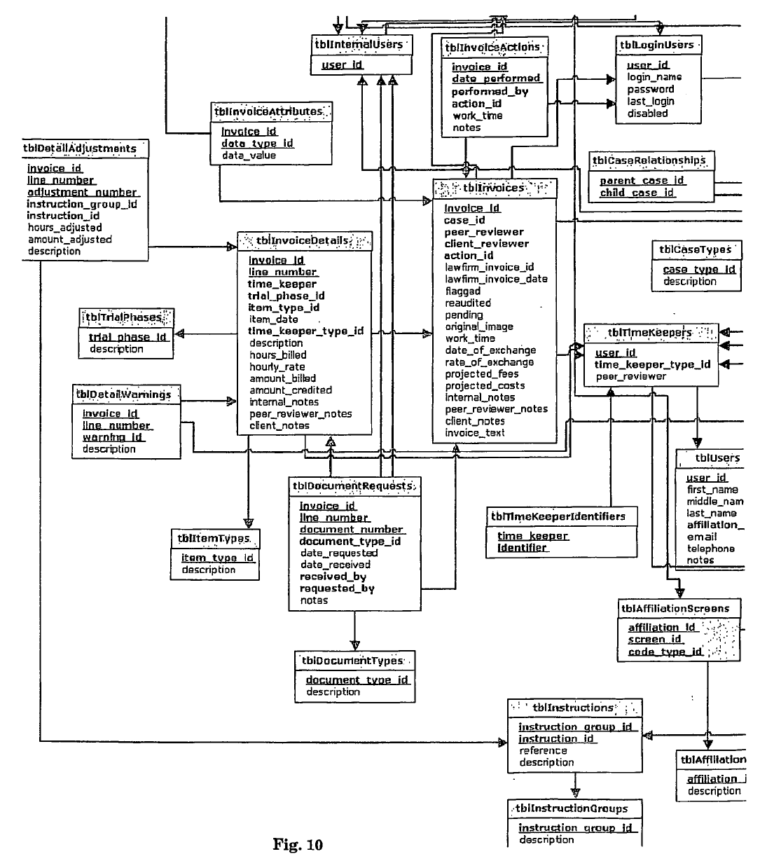

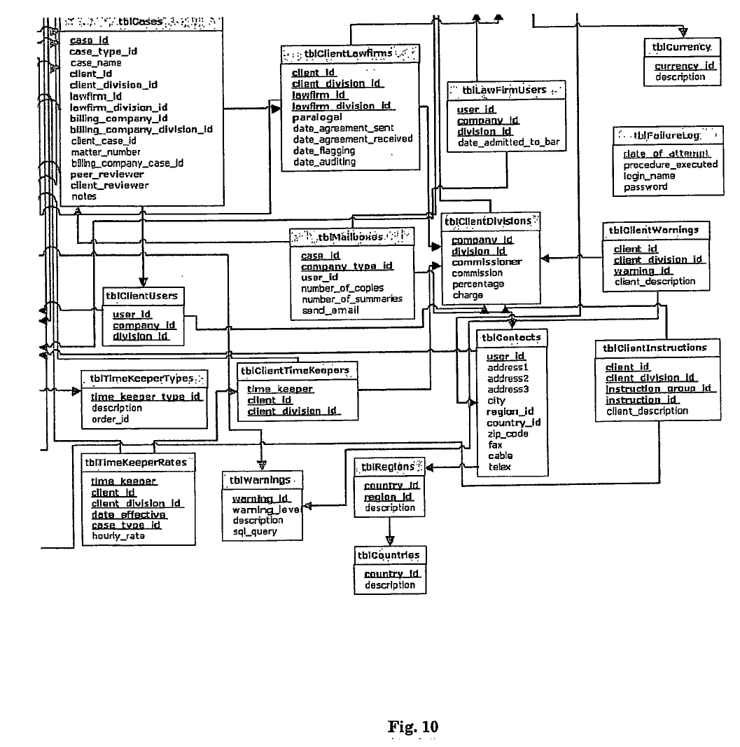

FIG. 10 is a block diagram showing the data tables in the system database, with the lines connecting the tables indicating table and data dependencies.

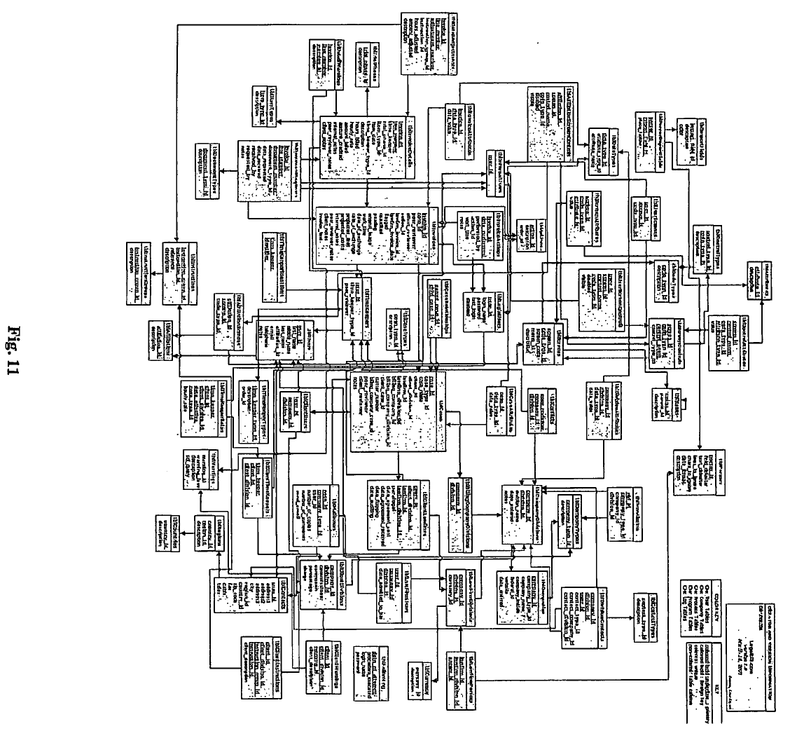

FIG. 11 is an integrated block diagram of the data tables shown in FIG. 10.

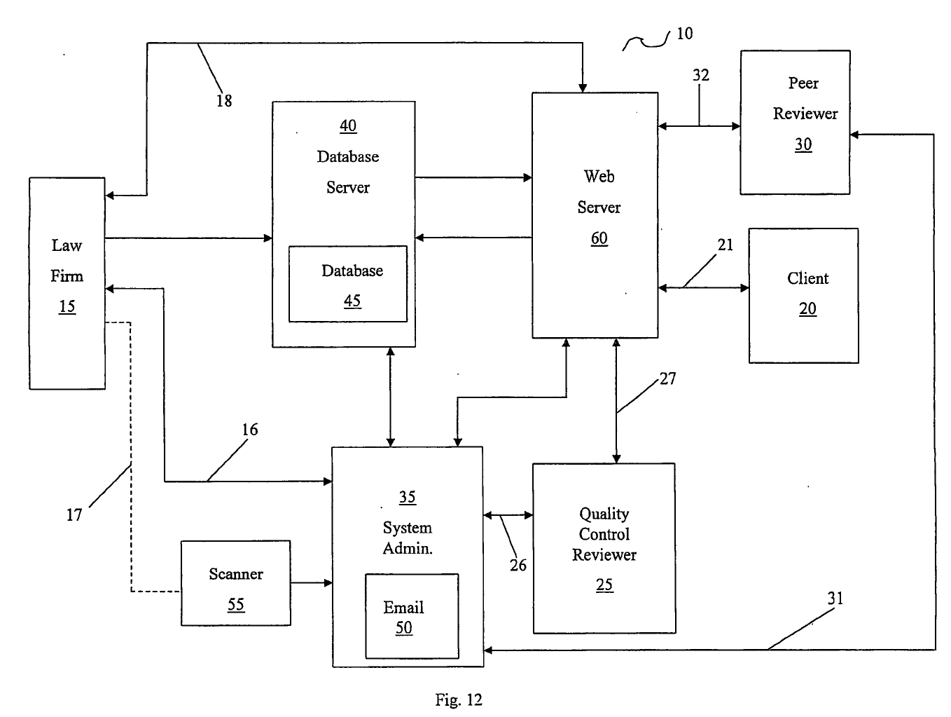

FIG. 12 is a block diagram of the invoice processing system of the present invention.

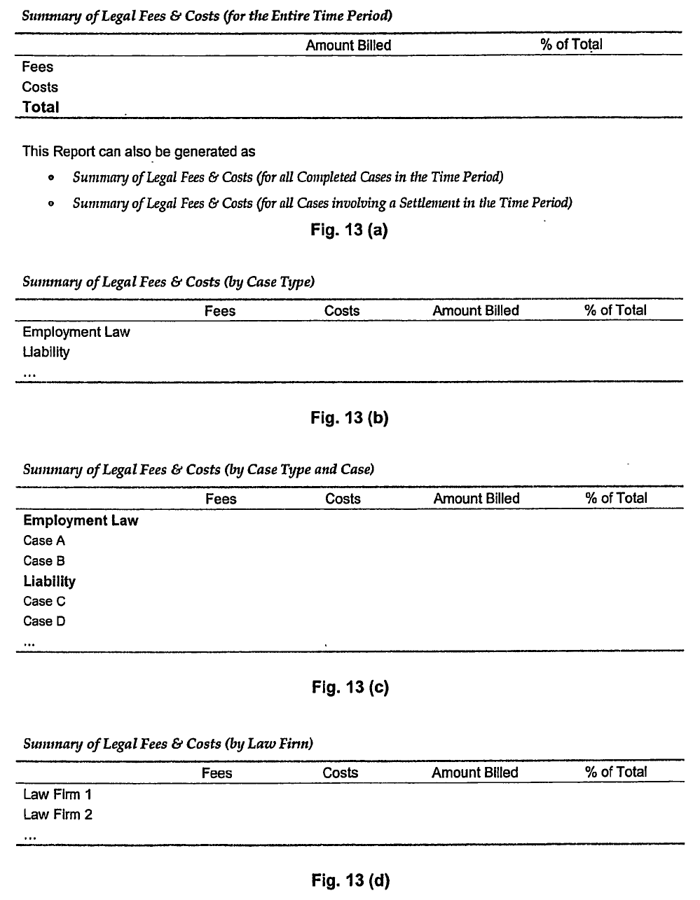

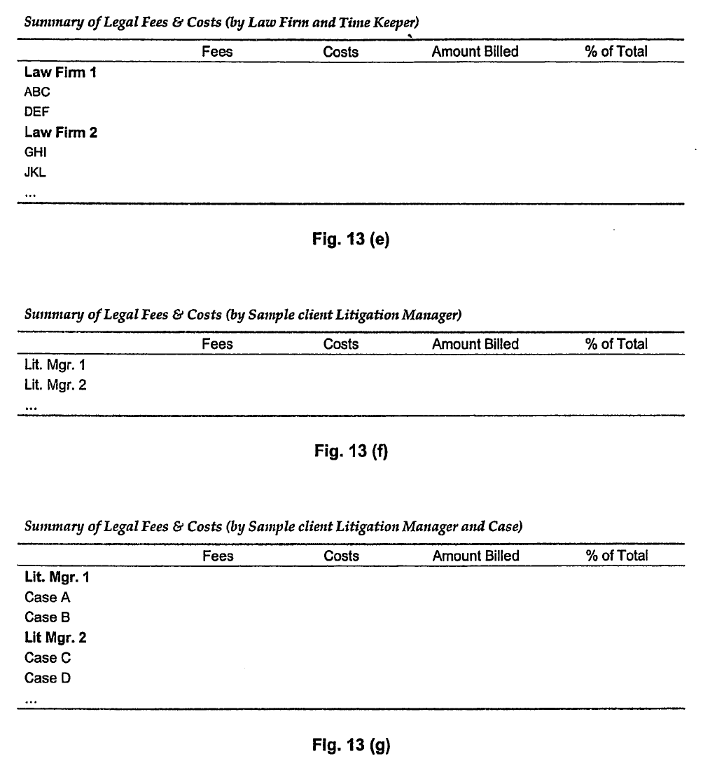

FIGS. 13(a)-(g) are sample client summary reports showing fees and costs invoiced by time period, generated by the system in response to a request from a client user made from the client menu page of FIG. 7(a).

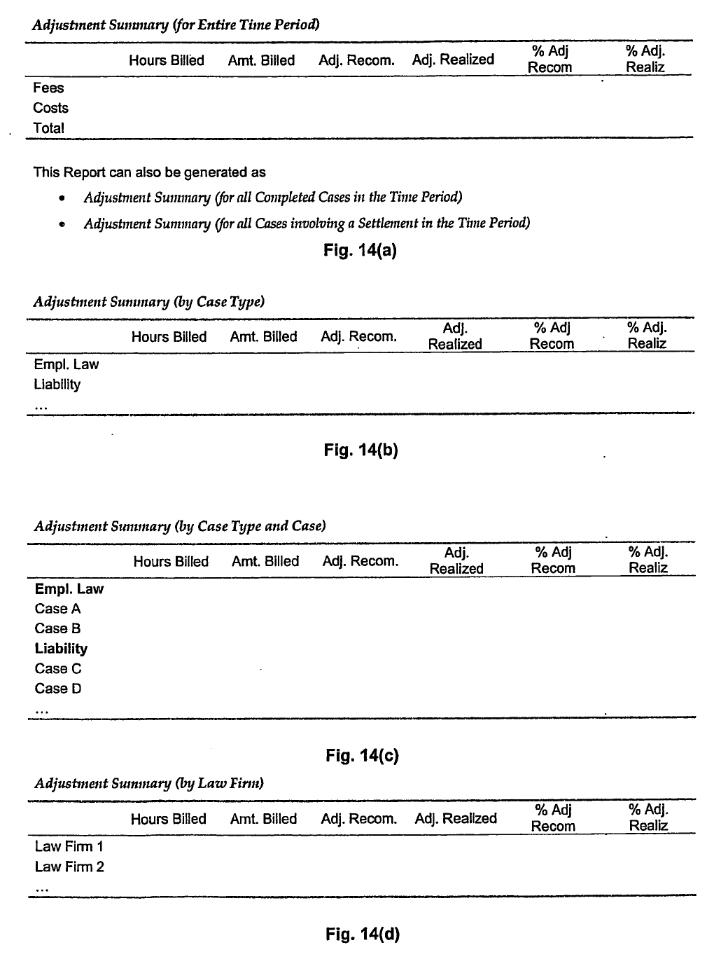

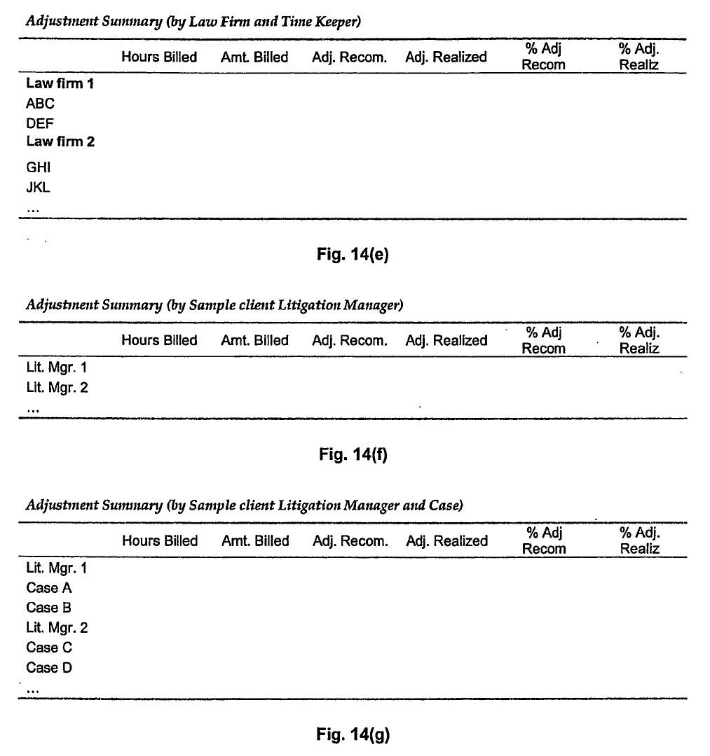

FIGS. 14(a)-(g) are sample client summary reports showing adjustments made to fees and costs by the system by time period, case-type, law firm, timekeeper, etc., as generated by the system from the client menu page of FIG. 7(a).

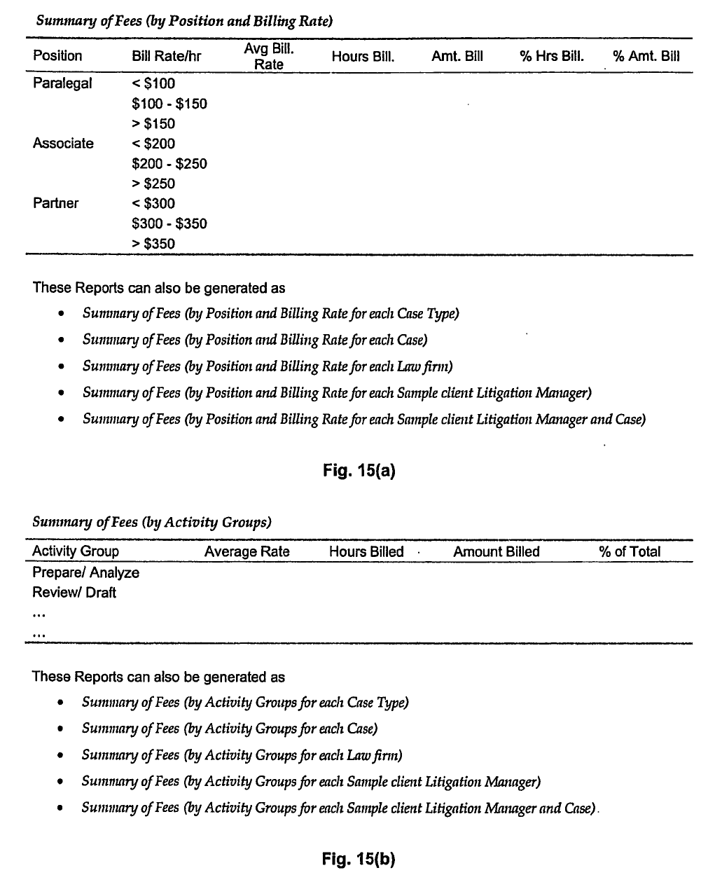

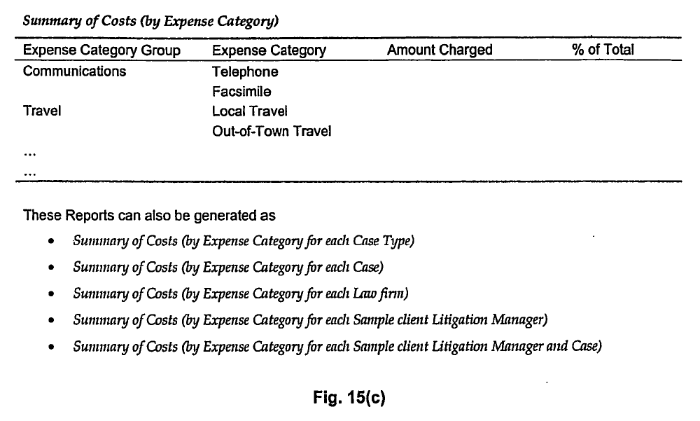

FIGS. 15(a)-(c) are sample client summary reports showing fees and costs invoiced by timekeeper position and rate, by activity group, and by cost category, as generated by the system in response to a in response to a request from a client user made from the client menu page of FIG. 7(a).

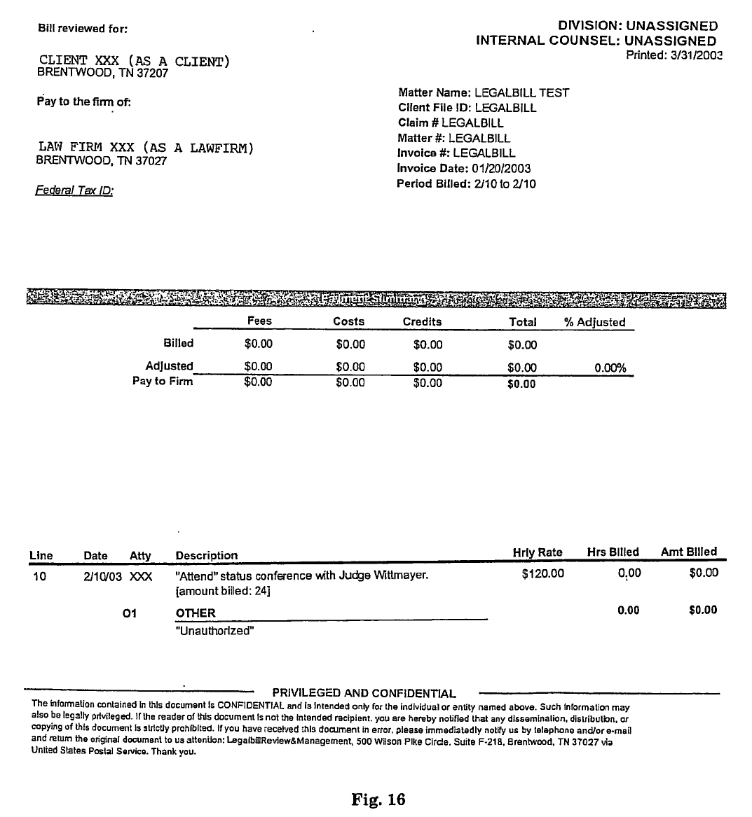

FIG. 16 is a sample client invoice report that is generated by the system and sent to the client after a law firm invoice has been audited.

### BEST MODE FOR CARRYING OUT THE INVENTION

The system and method of the present invention relies in substantial part on electronic processing of professional services invoices, including on-line quality control audits of invoices by peer reviewers and others. To accomplish this, each participant in the process will preferably have access to a personal computer (PC) or equivalent processing device and to a public network such as the internet, to facilitate the review and exchange of information pertaining to the invoices.

For purposes of explaining the structure and operation of the system in a preferred embodiment, a legal services firm (sometimes referred to as a law firm) submitting invoices for services to a corporate law department (sometimes referred to as the client) will be considered. The other participants in the process are the system provider, which acts as an intermediary between the law firm and the client for purposes of processing invoices (sometime referred to as “bills”), and peer review attorneys who may be employees of the system provider or independent contractors.

Referring to the block diagram of FIG. 13, the processing system 10 relies on the use of conventional PC's with internet web browsing software by the law firm 15, client 20, quality control reviewer 25, and peer reviewer 30. In addition, the system provider uses an administrative console PC 35 to control one or more database servers 40, including database software, to establish a system database 45 for storing, manipulating, searching, analyzing, extracting, and reporting invoice data associated with law firm invoices. The system administrative console 35 includes email software 50 to facilitate receipt of electronic invoices from the law firm (network connection 16) and to send notices to quality control reviewer 25 (connection 26) and to peer reviewer 30 (connection 31). At least one scanner 55 with optical character recognition (OCR) software is used for converting paper firm invoices received from the law firm into electronic files for use by the system. The paper files can be sent by mail (mail connection 17) or as a PDF file attachments to email sent across connection 16.

The system provider will also preferably operate one or more web servers 60 so that law firms can directly publish invoices and law firm information into the system using network connection 18. The quality control reviewer PC 25 also uses network connection 27 to perform preliminary quality control review of charge entries (fees and costs) on invoices that have been received by the system 10. Peer reviewers can review published invoices from their remote PC's 30 using network connection 32. Similarly, clients can use remote PCs 20 to review published invoices and post-audit reports at various stages of the process, across network connection 21. Preferably, network connections 16, 18, 21, 31, and 32 are implemented across a public network, such as the internet. Connections 26 and 27 can also be public network connections or local area network connections, if the quality control reviewer is an on-site employee of the system provider.

Also, in a preferred embodiment of the invention, the system 10 includes software modules that: (a) automatically prompt quality control staff and peer reviewers that invoices have been entered into the system and are ready for review; (b) provide quality control and peer reviewers access to all information needed to complete an audit of an invoice in the system; and (c) allow clients to manage matters by tracking tasks and projects using online customized databases containing invoice data extracted from the system database.

The hardware that implements these functions is entirely conventional and will not be described in detail herein. Also, there are a number of different database and web server software packages and platforms that can be combined with the hardware and programmed to carry out the methods and steps of the invention as described below. For example, VisualBasic scripts, Active Server Pages (ASP), SQL database applications, and other well-know programming tools can be used. MSXML (Microsoft EXtensible Markup Language) can be used for defining data elements on the web pages associated with the system.

Thus, a person of ordinary skill in computer programming can readily implement the steps and methods described herein, using only experience and the functional and other information supplied in this document.

Before processing of invoices submitted by a particular law firm to a particular client regarding a particular matter, certain categories of pre-processing information must be entered into the system database 45. At this stage, the client has entered into an invoice processing agreement with the system provider and the law firms providing services to that client are identified and directed to submit all invoices for services to the system provider. The pre-processing information that must be imported into the system includes: (1) billing rates and guidelines established by the client; (2) law firm information, including identification of the law firm's billing attorney and names and experience level of those law firm employees who will be providing services (“timekeepers”); (3) matter information describing the litigation or other project that for which services are being provided (sometimes referred to as a “case”); and (4) any special formatting associated with invoices that will be submitted electronically. As will be discussed below, the pre-processing information is generally available online to the quality control reviewers and peer reviewers while an invoice is being audited.

After the pre-processing information is received and entered into the system, the method of the invention generally includes five separate steps, beginning with importing one or more invoices into the system in a pre-defined electronic format (“Bill Input”) so that they can be subject to a complete auditing process. Next, the electronically formatted invoices are published (made available) to a quality control reviewer to insure that the invoice data reflects compliance with billing rates and guidelines established by the client (“Quality Control Review”). The invoices are then published for online review by experienced peer review attorneys (“Peer Review”). After the peer review step is complete, any recommendations made by the peer reviewer for adjustment of an invoice are coded into the system database as adjustment codes by a system provider staff member (“Post Audit”). Finally, the audited invoice is released by the system provider to the client for payment, along with reports summarizing certain quantitative and qualitative information associated with that invoice (“Bill Release”). Referring to FIGS. 1-7 and FIG. 12, these basic steps are described in more detail below.

Bill Input

When a user logs in at the login page of FIG. 1 with law firm credentials, the law firm menu page of FIG. 2(a) is displayed. Online instructions for submission of invoices to the system database 45 are displayed to law firms as shown in FIG. 2(b) if the “frequently asked questions” link is selected on the page of FIG. 2(a). Law firms may use a variety of different information transmission links to send their invoices to the system provider in either electronic or paper-based formats. Invoices in electronic form can be attached to email (connection 16 on FIG. 12), uploaded from a system web page (connection 18 on FIG. 12) or submitted on disk or other physical media and sent through by mail (connection 17). FIG. 3 is the invoice upload page displayed to a law firm user if the “upload invoices” link is selected on the menu of FIG. 2(a). The system allows the law firm user to “browse” (search for) electronic invoice files on the law firm PC 15.

Each invoice must include a header, a list of charge entries (fees and costs) and a footer. The detail lines comprising the list of charge entries must include an item date, description, hours billed and a timekeeper identification. System import software associated with administrative console 35 will import the invoice data for storage in system database 45.

If an invoice submitted electronically is not in a structured format (i.e., comma-delimited) a system clerk re-works the invoice file until it can be imported into the system database. The difficulty level of the re-working depends on the format of the original invoice. As long as the same category of invoice data can be placed in the same charge entry column consistently per invoice, the order of the information does not matter—the system import software can take the quasi-formatted data and properly import it into the database. If the bills are structured, then the importing is even easier. A system user must setup an invoice style sheet before an invoice can be imported. The invoice style sheet defines the formatting of the invoices that a particular law firm will be submitting. Once the invoice style sheet has been built, any future invoices from that law firm can be quickly imported into the system database. FIG. 2(b) provides additional detail about preferred formatting of invoices that are submitted to the system database 45 by a law firm.

Importing a paper invoice into the system database will normally include the steps of optically scanning (using scanner 55 on FIG. 12) the paper invoice, performing optical character recognition of the scanned image, and restructuring the scanned and recognized invoice data to conform to system formatting requirements.

The scanned or imported invoices are restructured so that, when viewed online, each invoice presents invoice data (e.g., charge entries) to quality control reviewers and peer reviewers in a visually consistent, easy to read, and useful format. An example of this is shown in FIG. 6, which represents a typical invoice page displayed to a peer reviewer. The system adds a line number to each charge entry and new data fields to the invoice to facilitate quality control review and peer review. Timekeeper type (“TK Type”) and rate fields identify the status and approved billing rate of the timekeeper. An adjustment text field is attached to each time (fee) and cost charge entry. This allows the quality control reviewer to enter adjustments to the time entry and to insert comments and questions for the peer reviewer to consider. The “Amt Credited” field reflects the net amount allowed for the charge entry after deduction of any adjustments. A peer review comment text field allows the peer reviewer to type comments and recommendations directly into the online invoice, as it is being displayed and reviewed.

The system also assigns an invoice control number to each invoice so that it can easily be tracked through the system and review processes.

Quality Control Review

Every client has a unique set of billing guidelines that define how any outside law firm working for that client should bill for its services. Billing guidelines can cover a wide variety of issues, including travel reimbursements, copying charges, postage fees, how intra-office conferencing is to be billed, bundling of time entries, level of detail needed, etc. Preferably, paralegals employed by the system provider use these guidelines to review the invoices for all non-qualitative violations of billing guidelines. For example, charging 12 cents per copy rather than the stated 10 cents per copy and expecting reimbursement for intra-city meetings when the guidelines explicitly state that only inter-city travel is eligible for reimbursement are two examples of billing infractions that can be objectively analyzed and do not require qualitative review by an attorney. The quality control reviewer performs this review online. If any billing guideline (or billing rate) violations are found, the dollar value of the charge entry is adjusted accordingly. The net amount credited is entered into the Amt Credited field and the reason for the adjustment is typed into the adjustment text field.

The quality control reviewer can also add comments and questions to flag the attention of the peer reviewer for possible further attention.

Peer Review

After the quality control review is completed, the electronic invoice is eligible for review by an attorney employed as a peer reviewer. Peer reviewers are chosen so that their legal experience and specialty areas are comparable to the experience and specialties of the law firm attorneys they are reviewing. Peer reviewers are responsible for examining the invoices for the appropriateness of the actions performed and for assessing if the time spent performing those actions was reasonable. If a peer reviewer is unsure of what happened with regard to a particular time entry or requires more information than what has been provided on an invoice, the peer reviewers are urged to call the law firm's billing attorney and speak with him about the matter.

Each peer reviewer is provided unique login credentials so that only those invoices matching that peer reviewer's capabilities can be viewed. Preferably, the system sends an email message to the peer reviewer when one or more invoices are ready for review. The message will contain an embedded hyperlink to the system peer review web site URL established by the system provider and a deadline for completing the review. To begin the peer review, the peer reviewer selects the link to load the system login page (FIG. 1) in his browser on the peer review PC 30. The peer reviewer then enters his/her login credentials. When the system recognizes the peer reviewer's credentials, the peer review menu page of FIG. 4 is displayed. At this point, the peer reviewer can review open invoices, checked out invoices, standardized adjustment codes, and client billing guidelines.

If the peer reviewer selects the “review open invoices” option (link) on the page of FIG. 4, the “Reviewing Invoices Online” page (FIG. 5) is loaded. This page contains a list of each open invoice assigned to that peer reviewer. The list entries include the invoice control number, the date the invoice was assigned to the peer reviewer, the name of the client, the name of the law firm, the case or matter name, and the number of lines (time/cost charge entries) in the invoice.

The peer reviewer then highlights and clicks on one of the invoices. In response to this action, the system loads a new page in separate window. This page represents and displays the selected electronic invoice as restructured by the system. Again, an example is shown in FIG. 6. Note that in addition to reviewing the invoice using the charge entry fields as discussed above, the peer reviewer has other options that are selectable from this page. These include instructing the system as to how many lines are to be displayed per page, paging back and forth through the invoice, or to “show all” of the invoice. The peer reviewer can also open up the corresponding billing guidelines, law firm information, and case information in a separate window by selecting the appropriate link.

Comments and recommendations are typed into the peer review comment text field displayed immediately below each time entry. The peer reviewer can select “save changes” to save comments and recommendations in a partially reviewed invoice and return later to complete it. This will occur, for example, when a peer reviewer has requested that the law firm supply a document reflecting work associated with a time entry so that it can be studied. The invoice remains open pending receipt and review of the requested document.

When the peer review is complete, the “Review Complete” button is selected. This causes the system to save all comments and recommendations, close the invoice window, and remove the invoice from the list of open invoices associated with that peer reviewer.

As also shown on FIG. 6, the invoice page also displays in separate fields the total amount of fees and costs invoiced by that law firm on that invoice and a “projected total” of what will be approved for payment after all adjustments.

Post Audit

After an invoice has completed quality control review and peer review, the substantive audit of the invoice is complete. However, the invoice is not yet ready to be released to the client for payment. First, all recommendations typed in by the peer reviewers must be coded into the system database 45. To control how data is coded into the system database, the peer reviewers are asked simply to write their comments for a particular invoice in note format in the text field (FIG. 6). Employees of the system provider, preferably the paralegals who perform quality control review, are responsible for interpreting the comments and assigning one or more standardized charge adjustment codes to the notes into the billing categories for the client in question. The use of adjustment codes in this manner allows the client to later run reports to look for and identify billing error or over-billing patterns associated with a particular law firm, etc.

Bill Release

After the quality control review and peer review audit and post-audit tasks are complete, the system generates a client invoice report. The client invoice report includes a payment summary, showing fees and costs billed on that invoice, credits, and adjustments. The client invoice report also shows each charge (time and cost) entry, along with any comments that the quality control reviewers (paralegals) and peer review attorneys have made so that the client and law firm know exactly what was adjusted and why it was adjusted. An example of a client invoice report is shown in FIG. 16. The client invoice report can be delivered electronically to the client PC 20 using a network connection 21 or simply printed and mailed.

The system 10 can also generate a variety of client summary reports in response to a request and selection entered by the client. These reports can be generated online after a client user of the system enters login credentials at the login page of FIG. 1. When the system recognizes the client login credentials, the client menu page of FIG. 7(a) is displayed in the browser of the client PC 20. From this page, the client can manage assigned and unassigned cases, review open invoices for that client, or generate case summary reports. Samples of these reports are shown in FIGS. 13-15. FIGS. 13(a)-(g) are sample client summary reports showing fees and costs invoiced to the client by time period. FIGS. 14(a)-(g) are sample client summary reports showing adjustments made to fees and costs by the system by time period, case-type, law firm, timekeeper, and litigation manager. FIGS. 15(a)-(c) are sample client summary reports showing fees and costs invoiced by timekeeper position and rate, by activity group, and by cost/expense category.

From the “review open invoices” page (not shown) the client also has web access to view a PDF file of the original law firm invoice as well as a restructured version as it has been input and modified by the system.

FIG. 7(b) shown the client case management page that is displayed in the browser of the client PC 20 if the “review unassigned cases” link is selected on the page shown in FIG. 7(a). All cases associated with that client are displayed if no client reviewer has been assigned.

FIG. 7(c) shows the “case summary” page if the “case summary” report link is selected on the page of FIG. 7(a). From this page, the client user can select from all cases associated with that client by case type and search by case name. A summary report similar to that shown in FIG. 16 is then generated for the selected case.

System Database and Software

Preferably, the system software will include one or more data access objects (DAO) as a programming interface that the system uses to access the system database. For example, supporting documentation, such as travel receipts, can be scanned into the system database and accessed on-line as part of the invoice audit. Survey information extracted from the entirety of the system database can be used to judge the time appropriateness of an action.

As noted above, the system database has two basic components, one that allows system provider personnel to locally access/modify information from their desktops and a second web-based component that allows clients and peer reviewers to access reports and bills to review from anywhere they can establish a 128-bit SSL (secure socket layer) link. FIG. 8 is a block diagram illustrating the software architecture of one embodiment of the system, including associated software instructions to cause the system to perform a technical procedure, e.g., to search the system database for information associated with a particular user name.

FIG. 9 is a block diagram of technical procedures implemented by the system software to access the system database. FIG. 10 is a block diagram showing the various data tables that comprise one embodiment of the system database. The lines connecting the tables indicate table and data dependencies. FIG. 11 is an integrated block diagram of the data tables shown in FIG. 10.

Although a preferred embodiment of the method and system of the invention has been described in the context of processing of law firm invoices, the invention can be used as well with invoices submitted by accountants and other providers of professional services.

Thus, although there have been described particular embodiments of the present invention of a new and useful “System and Method for Processing Professional Service Invoices”, it is not intended that such references be construed as limitations upon the scope of this invention except as set forth in the following claims.

1. A method of processing invoices submitted by a professional services firm for services provided to a client comprising:
a. importing the invoices in electronic form and storing invoice data from the invoices in a database as electronic invoices;
b. publishing the electronic invoices on a computer network to permit access to the electronic invoices by reviewers connected to the network;
c. using a quality control reviewer connected to the network, performing a quality control review of the electronic invoices to determine if adjustments to charges on the invoices should be applied based on non-compliance with billing guidelines set by the client;
d. using a peer reviewer terminal connected to the network, performing a peer review of the electronic invoices to determine if adjustments to charges on the invoices should be applied based on the presence of unnecessary or excessive charges in the invoices;
e. generating electronic client invoice reports, the client invoice reports reflecting adjustments made by the quality control and peer reviewers; and
f. transmitting the client invoice reports to the client.

2. The method of claim 1, the peer review step further comprising the peer reviewer entering text of adjustment recommendations into text fields associated with charge entries in the electronic invoices and entering standard adjustment codes into the database based on the text of the peer reviewer recommendations.

3. The method of claim 1 wherein the peer review step is performed across a public network connection between the database and the peer review terminal.

4. The method of claim 3 wherein the importing step includes restructuring invoices received from the professional services firm into a standard format.

5. The method of claim 3 wherein the importing step further comprises scanning paper invoices into electronic form prior to restructuring.

6. The method of claim 5 wherein the importing step further comprises receiving the invoices in electronic form from the professional services firm.

7. The method of claim 1 further comprising providing client summary reports to the client, the client summary reports comprising analysis of invoice data associated with the client by time period, by service provider, by timekeeper, or by case.

8. The method of claim 7 further comprising providing client summary reports to the client, the client summary reports comprising analysis of invoice data associated with the client by activity group or by cost/expense category.

9. A method of processing professional services invoices sent by a service provider to a client comprising:
a. directing the invoices sent by the client to a third-party invoice processor;
b. importing the invoices into database maintained by the invoice processor, the database storing invoice data associated with invoices as electronic invoices, the electronic invoices comprising one or more charge entries.
c. publishing the electronic invoices on a web server maintained by the invoice processor;
d. providing secure access to the published electronic invoices to at least one quality control reviewer and, across a public network, to at least one remotely located peer reviewer, whereby the reviewers can review charge entries from the published electronic invoices using a web browser and enter comments and recommendations into text fields associated with the charge entries;
e. adjusting charges associated with one or more of the charge entries in response to the comments and recommendations made by the quality control or peer reviewers; and
f. electronically transmitting the electronic invoices with the adjusted charge entries to the client across the public network.

10. The method of claim 9 further comprising storing client billing guidelines and service provider information in the database and providing the peer reviewer with web browser access to the billing guidelines and service provider information during peer review of the electronic invoices.

11. The method of claim 9 wherein the professional services firm is a law firm.

12. A system for processing invoices submitted prepared by a professional services firm for services provided to a client comprising:
(a) a database server including a system database for storing invoice data from the invoices and database software for managing the invoice data on the system database, the invoice data comprising one or more charge entries;
(b) a web server operatively linked to the database server and functional to publish at least some of the invoice data stored on the system database;
(c) an administrative console operatively linked to both the database server and the web server;
(d) at least one information transmission link operable to send the invoices from the professional services firm to the system;
(e) import software operable to import the invoice data from the invoices into the system database;
(f) a communications connection between the system database and a quality control reviewer personal computer to allow a quality control reviewer to review the charge entries and to add comments and charge adjustments to the invoice data associated with charge entries;
(g) a communications connection between the system database and a peer reviewer personal computer to allow a peer reviewer to review the charge entries and to add comments and recommendations to the invoice data associated with the charge entries; and
(f) a communications connection between the system database and the client, the communications connection functional to transmit a client invoice report to the client, the client invoice report reflecting the invoice data as adjusted by the quality control reviewer and the peer reviewer.

13. The system of claim 12 wherein the communications connections between the system database and the client and the peer reviewer PC comprises secure connections across a public network.

14. The system of claim 13 wherein the public network is the world wide web.
